(19) United States
(12) Patent Application Publication
(10) Pub. No.: US 2025/0098592 A1
(43) Pub. Date: Mar. 27, 2025

(54) ADAPTIVE CONTROL SYSTEM FOR OPTIMIZATION OF GRAIN HANDLING SYSTEMS

(71) Applicant: Sukup Manufacturing Co., Sheffield, IA (US)

(72) Inventors: Daniel Wayne Shrock, Raymondville, MO (US); Matthew Koch, Clear Lake, IA (US)

(21) Appl. No.: 18/971,475

(22) Filed: Dec. 6, 2024

Related U.S. Application Data
(63) Continuation-in-part of application No. 18/732,790, filed on Jun. 4, 2024.
(60) Provisional application No. 63/507,840, filed on Jun. 13, 2023.
(60) Provisional application No. 63/607,859, filed on Dec. 8, 2023.

(51) Int. Cl. A01F 12/58; A01F 25/18; A01F 25/20; A01F 25/22

(52) U.S. Cl. CPC A01F 12/58; A01F 25/18; A01F 25/20; A01F 25/22

(57) ABSTRACT

A system is presented for monitoring grain handling systems at a grain handling site. The system includes a central control system and one or more intermediate control devices communicatively connected to the grain handling systems. The central control system is configured to provide a first user interface configured to facilitate creation of a process flow and programming of the intermediate control devices to operate in accordance with the process flow. In one or more arrangements, the central control system is configured to control operation of grain handling systems to optimize the process flow for one or more performance parameters selected by a user.

### REFERENCE TO RELATED PATENT APPLICATION(S)

This application is a continuation-in-part of U.S. patent application Ser. No. 18/732,790, filed Jun. 4, 2024, and titled “SYSTEM FOR MONITORING AND CONTROL OF GRAIN HANDLING SYSTEMS”, which claims priority to U.S. Provisional Patent Application 63/507,840 filed on Jun. 13, 2023 and titled SYSTEM FOR MONITORING AND CONTROL OF GRAIN HANDLING SYSTEMS; and this application claims priority to U.S. Provisional Patent Application 63/607,859 filed on Dec. 8, 2023 and titled ADAPTIVE CONTROL SYSTEM FOR OPTIMIZATION OF GRAIN HANDLING SYSTEMS, all of which are hereby fully incorporated by reference herein in their entirety.

### FIELD OF THE DISCLOSURE

This disclosure relates to grain handling systems used in agriculture. More specifically and without limitation, this disclosure relates to monitoring and control systems for use with grain handling systems.

### OVERVIEW

Since the development of harvesting technology that is capable of separating desired grains from the surrounding chaff, new technologies have been developed to handle bulk quantities of grain. Some various grain handling systems that have been developed include but are not limited to, for example, technologies for storage of bulk grain, such as grain bins; and/or technologies for drying grain, such as grain dryers; technologies for loading, unloading and/or otherwise moving grain, such as grain conveyors (e.g., bucket elevators, drag chains, belt systems augers, and/or air systems), sweep systems, and/or grain levelers to name a few.

Some example grain dryers are described in U.S. Pat. No. 10,767,926 titled “MIXED-FLOW GRAIN DRYER WITH CROSS-FLOW VACUUM COOL HEAT RECOVERY SYSTEM” and issued Sep. 8, 2020, and U.S. patent application Ser. No. 16/990,257 titled “BRIDGE REDUCING MIXED-FLOW GRAIN DRYER WITH CROSS-FLOW VACUUM COOL HEAT RECOVERY SYSTEM”, filed on Aug. 22, 2020, and issued as U.S. Pat. No. 11,193,711 on Dec. 7, 2021, each of which is hereby fully incorporated by reference herein. Some example grain conveyors are described in U.S. patent application Ser. No. 17/194,413 titled “SINGLE DRIVE DUAL HOPPER CONVEYOR SYSTEM”, filed Mar. 8, 2021, and published as U.S. Patent Publication 2021/0284469 on Sep. 16, 2021, U.S. Patent Publication 2020/0196532 titled “AIR SYSTEM”, published Jun. 25, 2020, and U.S. patent application Ser. No. 16/997,333 titled “SWEEP SYSTEM FOR FULL ELEVATED FLOOR GRAIN BINS” filed Aug. 19, 2020, and published as U.S. Patent Publication 2021/0051856 on Feb. 25, 2021, each of which is hereby fully incorporated by reference herein. Some example grain bins are described in U.S. patent application Ser. No. 17/346,373 titled “SELF-OPENING AIRTIGHT ROOF VENT SYSTEM FOR GRAIN STORAGE DEVICES” filed Jun. 14, 2021, and published as U.S. Patent Publication 2021/0392820 on Dec. 23, 2021, and U.S. Pat. No. 10,407,935 titled “DOUBLE END STUD BOLT AND METHOD OF USE” and issued Sep. 10, 2019, each of which is hereby fully incorporated by reference herein.

For simplicity purposes, reference is made herein to grain. However, the disclosure is not intended to be limited to grain. Instead, the disclosure is intended to apply to corn, soybeans, wheat, rice, nuts, popcorn, pistachios, small grains, large grains, unprocessed grains, processed grains, foodstuffs, unprocessed foodstuffs, processed foodstuffs, other commodities, or any other grain or agricultural products or other flowable material. As such, unless specifically stated otherwise, reference to grain is intended to include all forms of corn, soybeans, wheat, rice, nuts, popcorn, pistachios, small grains, large grains, unprocessed grains, processed grains, foodstuffs, unprocessed foodstuffs, processed foodstuffs, other commodities, or any other grain or agricultural products or other material.

Many agricultural handling systems are prone to interrupted operation due to various faults that may occur in operation of grain handling system. As one example, due to inconsistency of grain characteristics such as in weight, size, moisture content, debris or fines content, and the like, grain is subject to clumping or clogging within grain handling systems.

This means that a grain handling system may be optimally performing one moment can be disabled the next. As another example, despite heavy duty construction, components of grain handling systems are subject to failure due to excessive load and runtimes experienced in processing large quantities of grain. As yet another example, a destination grain bin may become full or a source may be completely emptied.

Failure of grain handling systems is exacerbated in that typically several grain handling systems are operated concurrently in a chain with grain being continuously transferred from one system to the next. Moreover, failure occurring in one grain handling system can cause problems in other systems upstream or downstream (depending on the systems involved), which may lead to damage and/or loss of grain, backing up of systems, and/or damaging systems. Due to the large potential energy of the large amounts of grain and/or machinery, nearby workers may face bodily harm when failures occur. As such, grain handling systems require constant oversight to ensure they are operating properly and ensure appropriate actions are taken when failure occurs to prevent harm to nearby personal, mitigate further damages to equipment, and/or mitigate loss of the grain being processed.

Some grain handling sites employ automated control systems to perform a series of predetermined actions when failure of a grain handling system is detected. The appropriate actions to be taken may vary greatly depending on the type, capabilities, and setup of equipment employed. Due to the complex interoperation of different equipment, determining appropriate predetermined actions for every possible scenario can be challenging and daunting task. To handle such complexity, there are professional programmers who specialize in programing of grain handling equipment. Such programmers may be needed review and reprogram control systems whenever new equipment is added, replaced, and/or updated. The expense of such programing services can add significant expense to operation of grain handling equipment over the lifetime of such equipment.

Therefore, for all the reasons stated above, and the reasons stated below, there is a need in the art for an improved control system for grain handling systems.

Thus, it is a primary object of the disclosure to provide a control system for grain handling systems that improves upon the state of the art.

Another object of the disclosure is to provide a control system that facilitates easy setup and configuration of grain handling systems.

Yet another object of the disclosure is to provide a control system that facilitates setup and configuration of grain handling systems without manual programing.

Another object of the disclosure is to provide a control system for grain handling systems that automatically optimizes grain handling systems for one or more performance parameters.

Yet another object of the disclosure is to provide a control system for grain handling systems that dynamically optimizes grain handling systems during operation for one or more performance parameters.

Another object of the disclosure is to provide a control system for grain handling systems that is easy to use.

Yet another object of the disclosure is to provide a control system for grain handling systems that is scalable.

Another object of the disclosure is to provide a control system for grain handling systems that is adaptable.

Yet another object of the disclosure is to provide a control system for grain handling systems that is reliable.

Another object of the disclosure is to provide a control system for grain handling systems that can operate without an internet connection. Yet another object of the disclosure is to provide a control system for grain handling systems that is easy to manufacture.

Another object of the disclosure is to provide a control system for grain handling systems that is durable.

Yet another object of the disclosure is to provide a control system for grain handling systems that has a robust design.

Another object of the disclosure is to provide a control system for grain handling systems that is relatively inexpensive.

Yet another object of the disclosure is to provide a control system that is high quality.

Another object of the disclosure is to provide a control system that can be used with any grain handling system.

These and other objects, features, or advantages of the disclosure will become apparent from the specification, figures, and claims.

### SUMMARY OF THE DISCLOSURE

In one or more arrangements, a system for monitoring and control of grain handling systems is provided. In one or more arrangements, the system includes a control system and one or more of intermediate control devices communicatively connected to the control system. The intermediate control devices are also communicatively connected to the grain handling systems. The control system is configured to provide a first user interface configured to facilitate creation of a process flow. In one or more arrangements, the process flow indicates: a set of the grain handling system to be used for handling grain in the process flow, an order in which the set of grain handling systems handle grain in the process flow, a set of error parameters indicating conditions for detecting when the error has occurred in the process flow, and a set of control parameters indicating actions to be performed in response to detecting an error in the process flow. The control system is configured to monitor statuses of the set of the one or more grain handling systems during operation of the process flow.

In one or more arrangements, in response to detecting an error in the process flow, the control system is configured to prompt the plurality of intermediate control devices to cause the set of the grain handling systems to perform the set of actions indicated by the set of control parameters. In one or more arrangements, the set of control parameters include control parameters to be used when an error occurs before the grain handling systems in the process flow and control parameters to be used when an error occurs after the grain handling system in the process flow. In one or more arrangements, creation of the process flow with the user interface includes presenting a list of grain handling systems installed at the grain handling site; selecting one or more grain handling systems to be used in the process flow from the list of grain handling systems; selecting the set of error parameters; and selecting the set of control parameters.

In one or more arrangements, the control system is configured to automatically adjust one or more control settings for the grain handling systems during operation to optimize the process flow for a selected performance parameter. In some arrangements, the control system is configured to dynamically perform optimization during operation, for example, to adjust optimization for changes in environmental conditions that may affect processing of grain.

### BRIEF DESCRIPTION OF THE DRAWINGS

FIG. 1 shows a diagram of a system for configuration and control of grain handling systems, in accordance with one or more arrangements; the view showing a central controller communicatively connected with an example set of grain handling systems via intermediate control devices.

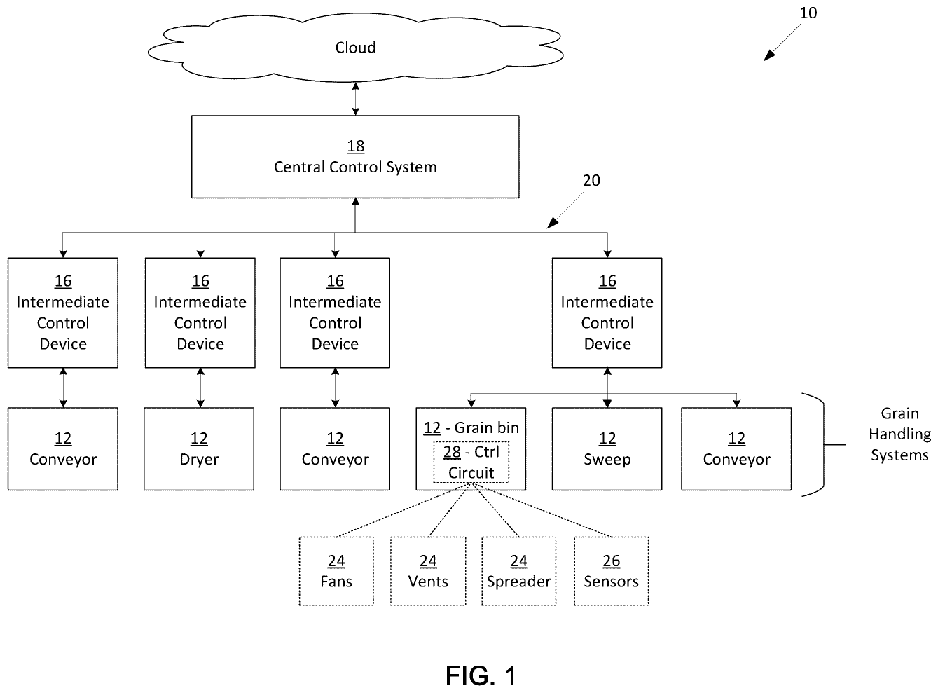

FIG. 2 shows a diagram of a system for configuration and control of grain handling systems, in accordance with one or more arrangements; the view showing a central controller communicatively connected with an example set of grain handling systems; the view showing the central controller configure to implement an example process flow.

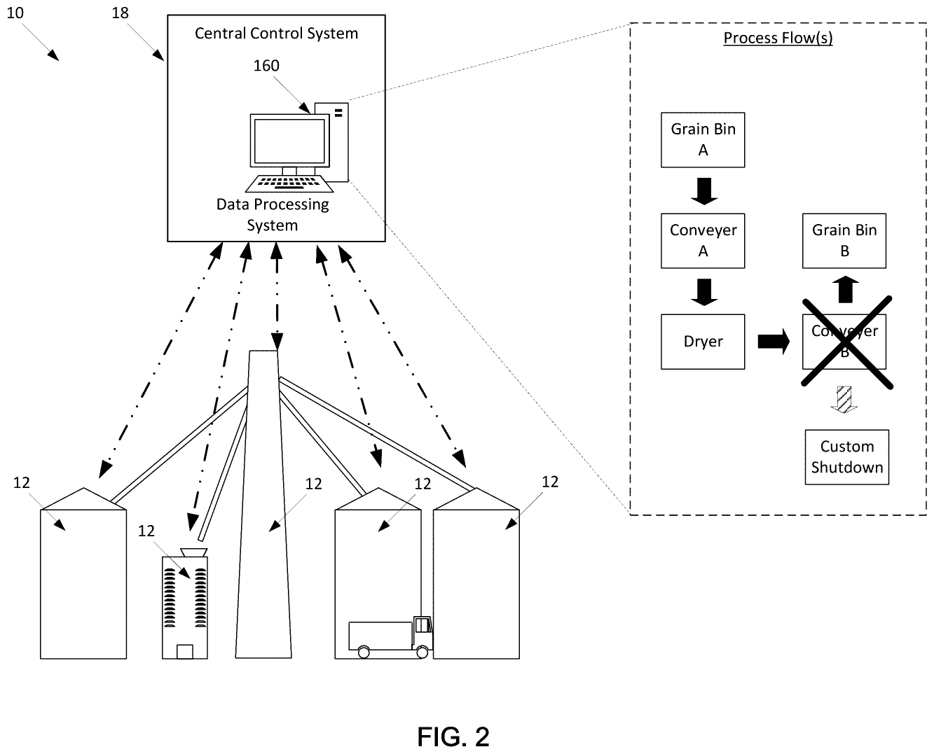

FIG. 3 shows an example process for installation and setup of an intermediate control device, in accordance with one or more arrangements.

FIG. 4 shows an example process for creation of a process flow, in accordance with one or more arrangements.

FIG. 5 shows an example process for monitoring and controlling grain handling systems according to a user created process flow, in accordance with one or more arrangements.

FIG. 6 shows a screen shot of an example user interface for a system for configuration and control of grain handling systems, in accordance with one or more arrangements; the view showing the user interface with a controllers & equipment dashboard displayed.

FIG. 7 shows a screen shot of an example user interface for a system for configuration and control of grain handling systems, in accordance with one or more arrangements; the view showing a process flow dashboard of the user interface configured to permit end users to create process flows for operation of select group of grain handling systems to perform desired tasks.

FIG. 8 shows a screen shot of an example user interface for a system for configuration and control of grain handling systems, in accordance with one or more arrangements; the view showing the process flow dashboard shown in FIG. 7 with information for an example process flow displayed.

FIG. 9 shows a screen shot of an example user interface for a system for configuration and control of grain handling systems, in accordance with one or more arrangements; the view showing the process flow dashboard shown in FIG. 7 with an interface window presented to facilitate creation of a new process flow.

FIG. 10 shows a screen shot of an example user interface for a system for configuration and control of grain handling systems, in accordance with one or more arrangements; the view showing the user interface as shown in FIG. 9 with an interface window presented to facilitate customization of error parameters for use with the process flow.

FIG. 11 shows a screen shot of an example user interface for a system for configuration and control of grain handling systems, in accordance with one or more arrangements; the view showing the user interface with interface window presented to facilitate customization of control parameters for use with a process flow.

FIG. 12 shows a screen shot of an example user interface for a system for configuration and control of grain handling systems, in accordance with one or more arrangements; the view showing the user interface with an example pop-up window presenting a warning that a particular control parameter is atypical and may lead to damage to equipment, loss of grain, or harm to workers.

FIG. 13 shows a diagram of an example data processing system that may be used to implement systems, circuits, components, and/or processes of a central control system and/or intermediate control devices, in accordance with one or more arrangements.

FIG. 14 shows a screen shot of an example user interface to facilitate graphical arrangement of grain handling systems and/or other equipment as they are deployed on a site, in accordance with one or more arrangements.

FIG. 15 shows a diagram of a system for configuration and control of grain handling systems, in accordance with one or more arrangements; the view showing a central controller communicatively connected with an example set of grain handling systems via intermediate control devices; the view showing an adaptive control system implemented by the central control system.

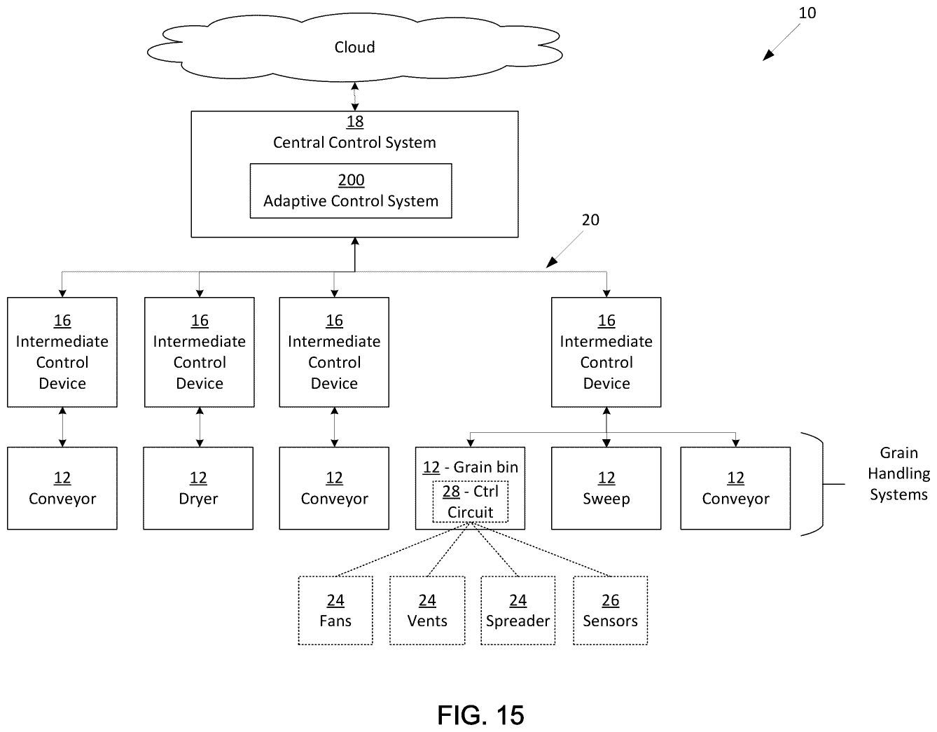

FIG. 16 shows a diagram of a system for configuration and control of grain handling systems, in accordance with one or more arrangements; the view showing a central controller communicatively connected with an example set of grain handling systems via intermediate control devices; the view showing an adaptive control system and an advance warning system implemented by the central control system.

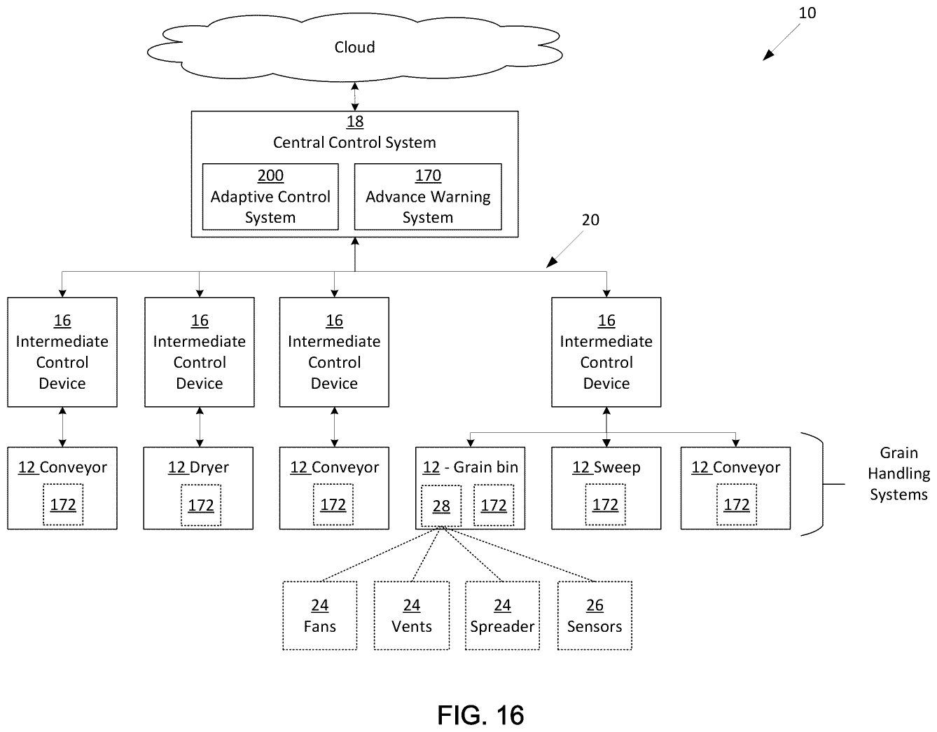

FIG. 17 shows an example process for optimization operation of grain handling systems for a set of performance parameters, in accordance with one or more arrangements.

FIG. 18 shows a graphical depiction of individual operating speed ranges for five grain handling systems of a hypothetical process flow for moving wet grain from a wet storage grain bin through a grain dryer and into a bin for storage, in accordance with one or more arrangements.

FIG. 19 shows the graph of FIG. 18 with a hard constraint depicted (illustrated as solid black) on the operating speed for the grain dryer.

FIG. 20 shows the graph of FIG. 19 with a compatible control settings (e.g., compatible with the hard constraint on operating speed of the grain drier) shown for other grain handling systems 12 in the process flow.

FIG. 21 shows an example process for dynamic optimization of a process flow for one or more performance parameters, in accordance with one or more arrangements.

FIG. 22 shows an example high level process for optimizing a process flow for primary and secondary performance parameters, in accordance with one or more arrangements.

FIG. 23 shows a graphical depiction of individual operating speed ranges for optimization for the hypothetical example shown in FIGS. 18-20; the view showing optimization ranges for secondary performance parameters after optimizing the flow for throughput as the primary performance parameter.

FIG. 24 shows a graphical depiction shown in FIG. 23 with secondary performance parameters optimized.

FIG. 25 shows a graphical depiction of individual operating speed ranges for optimization for the hypothetical example shown in FIGS. 18-20; the view showing optimization ranges for secondary performance parameters after optimizing the flow for energy use of grain drier for a set throughput as the primary performance parameter.

FIG. 26 shows a graphical depiction shown in FIG. 25 with secondary performance parameters optimized.

FIG. 27 shows a screen shot of an example user interface with a pop up window interfaces for user configuration of performance parameters, in accordance with one or more arrangements.

FIG. 28 shows a screen shot of an example user interface with a pop up window interfaces for user configuration of operating constraints, in accordance with one or more arrangements.

FIG. 29 shows an example process for optimization of operating speed of grain handling devices to maximize throughput, in accordance with one or more arrangements.

FIG. 30 shows another example process for optimization of operating speed of grain handling devices to maximize throughput, in accordance with one or more arrangements.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

It should be understood that any advantages and/or improvements discussed herein may not be provided by various disclosed embodiments, and/or implementations thereof. The contemplated embodiments are not so limited and should not be interpreted as being restricted to embodiments that provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments that address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure. Moreover, although some disclosed embodiments may be described in the context of window treatments, the embodiments are not so limited. In is appreciated that the embodiments may be adapted for use in other applications which may be improved by the disclosed structures, arrangements and/or methods.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments and/or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of grain handling system. However, the embodiments are not so limited. It is appreciated that the embodiments may be adapted for use in other applications which may be improved by the disclosed structures, arrangements and/or methods. The system is merely shown and described as being used in the context of grain handling systems for ease of description and as one of countless example applications.

### System 10:

Turning now to the figures, a control system 10 (or simply system 10) is presented for configuration and control of grain handling systems 12, as is shown as one example. In the arrangement shown, as one example, control system 10 includes a central control system 18 and a set of intermediate control devices 16 communicatively connected with the central control system 18 (e.g., via one or more data networks 20) and with the grain handling systems 12, among other components.

### Grain Handling Systems 12:

Control system 10 may be used with various different grain handling systems 12 and arrangements thereof. Grain handling systems 12 are formed of any suitable size, shape and design, and are configured to facilitate loading/unloading of grain, transportation of grain, processing of grain, treatment of grain, storage of grain, evaluation/monitoring of grain, and/or or any other function related to handling of grain. As some illustrative examples, at some different grain handling sites, the various grain handling systems 12 may include but are not limited to, for example, grain pits, grain hoppers, grain conveyors (e.g., belt conveyors, drag chain conveyors, bucket conveyor, auger conveyors, and/or air system conveyors), grain dryers, grain bins, sweep systems, and/or any other type of grain handling system.

In one or more arrangements, as one example, a grain handling system 12 may include various equipment 24 (e.g., machinery, devices and/or other equipment), sensors 26, and/or control circuits 28, among other components.

### Controllable Equipment 24:

Equipment 24 is formed of any suitable size, shape and design, and is configured to perform a grain handling related function, involved in the processing and storage of grain from harvest to date of transportation from the grain handling site, that is operated by or controlled by an electronic signal. As some illustrative examples, in some arrangements, equipment 24 may include but is not limited to, for example, motorized or electronically actuated devices that may be operated by or controlled by electrical signals (e.g., vents, doors, sumps, augers, drag chains, spreaders, sweeps, fans, roof exhausters, heaters, lights, flow gates, leveling equipment, and/or any other grain handling related equipment).

### Sensors 26:

In some arrangements, one or more grain handling systems 12 include one or more sensors 26 to facilitate monitoring of grain condition, environmental factors, operation of equipment or any other factor or data metric relevant to the handling of grain. In some various arrangements, sensors 26 may include but are not limited to, for example, temperature sensors, humidity sensors, moisture sensors, pressure sensors, grain flow sensors, chemical sensors, optical sensors (e.g., cameras), motion sensors, light sensors, sound or vibration sensors, RF sensors, interlock switches, voltage and/or current sensors, positional sensors, geolocation sensors, and/or any other type of sensor. In some arrangements, sensors 26 may be formed along with control circuit 28 and/or equipment 24 a single combined component. Alternatively, in some arrangements, sensors 26 may be separated components from control circuit 28 and/or equipment 24.

### Control Circuit 28:

Control Circuit 28 is formed of any suitable size, shape, and design and is configured to control operation and/or configuration of equipment 24 in a grain handling system 12. Depending on the manufacture, types, and particular model, commercially available grain handling systems 12 may control circuits 28 with various different levels of features, capability, and/or interfaces for remote control by other devices and/or systems. In some grain handling systems 12, the control circuit 28 may provide sophisticated scheduling monitoring, and/or configuration and/or adjustment of operation. Conversely, in some grain handling systems 12, the control circuit 28 may comprise a simple on/off switch. Moreover, in grain handling systems 12 having a control circuit 28 that provides for control and/or configuration by other devices and/or systems, the control circuit 28 may be configured to communicate using any number of different standard or proprietary protocols and/or commands. Accordingly, interconnecting and coordinating control of the grain handling systems 12 can be a challenging and time consuming task.

### Intermediate Control Devices 16:

Intermediate control device 16 is formed of any suitable size, shape, and design and is configured to communicatively connect with central control system 18 and control circuits 28 of one or more grain handling systems 12 to facilitate control of the grain handling systems 12 as directed by and/or configured by central control system 18. In some various arrangements, intermediate control device 16 system 10 may be implemented using various different commercially available and/or custom-built controller circuits to control operation of grain handling systems 12.

### Central Control System 18:

Central control system 18 is formed of any suitable size, shape, and design and is configured to communicate with intermediate control devices 16 to facilitate installation and configuration and/or programming intermediate control devices 16 and/or grain handling systems 12 to operate grain handling systems 12 as desired by a user.

### Installation and Configuration:

In one or more arrangements, central control system 18 is configured to provide one or more user interfaces configured to facilitate the installation and configuration and/or programming intermediate control devices 16 and/or grain handling systems 12. In one or more arrangements, in response to user input, central control system 18 is configured to search and detect new intermediate control devices 16, facilitate selection of intermediate control devices 16, and facilitate selection of the grain handling system(s) 12 that will be controlled by the intermediate control devices 16. In one or more arrangements, central control system 18 is configured to automatically determine control/interface protocols for a selected intermediate control devices 16 and grain handling system(s) 12 and configure the intermediate control devices 16 to communicate with and operate the selected grain handling system with a default set of error handling behavior.

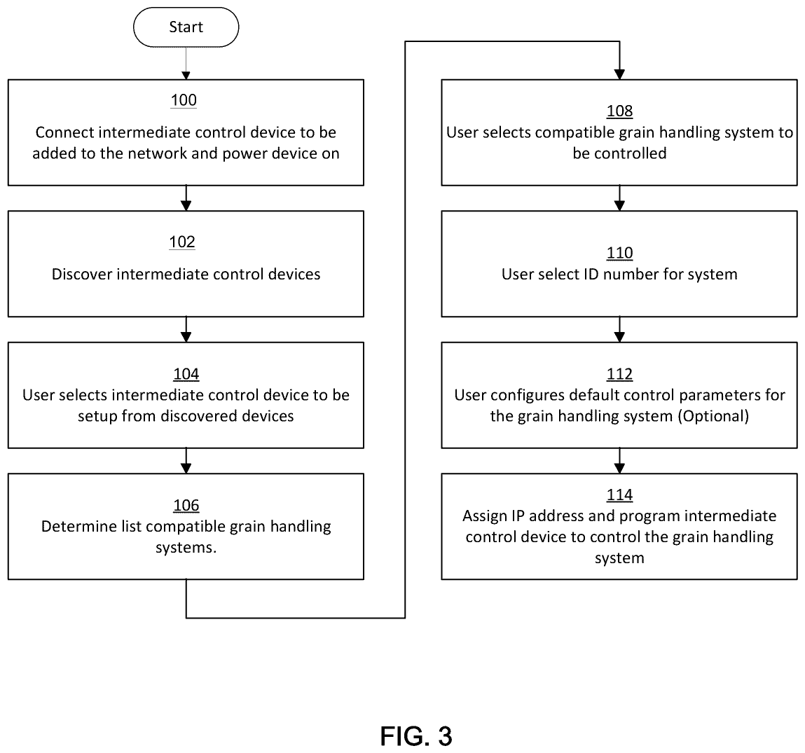

FIG. 3 shows an example process for installation and setup of an intermediate control device 16, in accordance with one or more arrangements. In this example, at process block 100 a user connects a new intermediate control device 16 to the network 20 and powers the intermediate control device 16 on. At process block 102, user prompts central control system 18 to discover new intermediate control device 16 on the network 20. In this example process, at process block 104, the user selects in intermediate control device 16 to be installed and/or setup from the discovered intermediate control devices 16. At process block 106, central control system 18 determines a list of grain handling systems 12 that are compatible with the selected intermediate control device 16. At process block 108, the user selects one or more compatible grain handling systems 12 that will be controlled by the selected intermediate control device 16. In this example process, the user selects an available ID number for the selected grain handling system(s) 12 that will be controlled by the selected intermediate control device 16. At process block 112, the user optionally may configure default control parameters and/or settings from the for the selected grain handling system(s) 12. In one or more arrangements, such default control parameters and/or settings may direct how the particular grain handling system(s) 12 operate and/or handle errors in absence of contrary configuration by an applicable process flow. In this example, at process block 114, central control system 18 automatically assigns an IP address to intermediate control device 16 and programs intermediate control device 16 to control the selected compatible grain handling systems 12 according to default configuration settings or any settings specified by the users at process block 112 (if any).

In some various different arrangements, programming of intermediate control device 16 by central control system 18 may include various different tasks or processes including but not limited to, for example: configuring intermediate control device 16 to communicate with the selected grain handling system(s) 12 (and/or control circuits 28 thereof) using the appropriate communication protocols and commands, configuring intermediate control device 16 with logic to monitor and/or control operation of the selected grain handling system(s) 12 in accordance with the set of default and/or user specified configuration and/or settings; testing of grain handling system(s) 12, control circuits 28, and/or intermediate control device 16 to verify correct configuration (e.g., verify user specified the correct grain handling system), and/or any other task or process that may be useful for configuration and/or setup of intermediate control device 16 and/or selected grain handling system(s).

However, the arrangements are not so limited to the example processes for installation and setup of an intermediate control device 16. Rather, it is contemplated that in some various arrangements, central control system 18 may be configured to implement various suitable additional or alternative processes to facilitate installation and setup of an intermediate control device 16.

### Process Flow Creation:

In one or more arrangements, central control system 18 is configured to provide one or more user interfaces configured to facilitate the creation of process flows to facilitate operation of a one or more grain handling systems 12 controlled by installed intermediate control devices 16 in a desired sequence. In one or more arrangements, a process flows defines a set of grain handling systems 12 included in the process flow, the order in which the set of grain handling systems 12 are to process grain, a set of error parameters indicative of when an error has occurred in the process flow, and a set of actions to be taken when an error occurs in one of grain handling systems 12 in the process flow.

In one or more arrangements, the actions to be taken when an error is detected specify a first set of actions to be performed by a grain handling system 12 when the error occurs upstream of the grain handling system 12 in the process flow and a second set of actions to be performed by a grain handling system 12 when the error occurs downstream of the grain handling system 12 in the process flow.

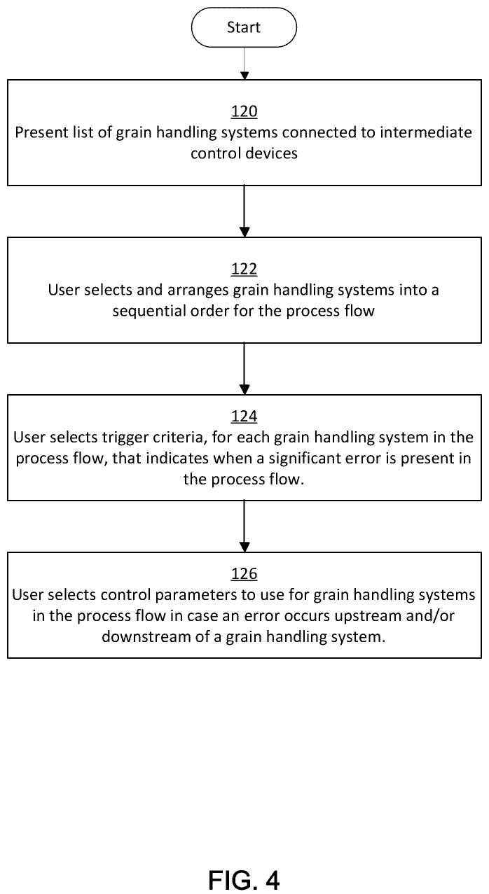

FIG. 4 shows an example process for creation of a process flow, in accordance with one or more arrangements. In this example, at process block 120, a user is presented with a list of grain handling systems 12 that the intermediate control devices 16 are configured to control. At process block 122, the user selects and arranges desired grain handling systems 12 from the list into a sequential order for the process flow. At process block 124, the user selects error parameters, for each grain handling system 12 in the process flow, that indicate when a significant error is present in the process flow. At process block 126, the user selects control parameters to use for the grain handling systems 12 in the process flow in case an error occurs upstream and/or downstream of the particular grain handling systems 12 in the process flow. Generally, grain handling systems 12 are configured with their own processes to perform when an error occurs within the grain handling system 12 itself. However, in one or more arrangements, adaptive control system 200 may permit a user to customize or specify (e.g., at process block 126) additional/alternative error handling processes for a grain handling system 12 to perform when an error occurs within the grain handling system itself. In one or more arrangements, when a process flow is created, the user selects error parameters (indicative of when an error has occurred) for each grain handling system 12 in the process flow. However, the arrangements are not so limited. Rather, it is contemplated that in one or more arrangements, central control system 18 may be configured to use default error detection criteria for a grain handling system 12 if none is specified by a user in the process flow.

Similarly, in one or more arrangements, when a process flow is created, the user selects control parameters (e.g., indicative of actions to be performed for upstream errors, downstream errors, and/or local errors) for each grain handling system 12 in the process flow. However, the arrangements are not so limited. Rather, it is contemplated that in one or more arrangements, central control system 18 may be configured to use default control parameters for a grain handling system 12 if none is specified by a user in the process flow.

In various different arrangements, central control system 18 may cause intermediate control devices 16 and/or grain handling system 12 to implement various different control parameters when errors occur depending on the type, arrangement, and configuration/settings of grain handling systems 12 for a particular process flow. Such control parameters may include but are not limited to, for example, immediate shutdown of a system, shutdown with cleanout, and/or continued operation of the system (e.g., potentially with or without adjustment of operation settings). However, the arrangements are not so limited. Rather, it is contemplated that in some arrangements, central control system 18 may permit a user to select from any number of different control parameters to direct operation when errors occur in a process flow.

In one or more arrangements, a user may additionally or alternatively specify non-default operation settings for grain handling system 12 when a process flow is created. Operation settings for some various grain handling systems 12 may include but are not limited to for example, operation speed, modes of operation, operating temperatures, operating pressure, duration of operation, start/stop times, or any other available setting on grain handling systems 12. In this manner, process flows may be created more easily since error handling criteria, error handling actions, and/or other non-default operation settings need only be specified if they are being customized by a user.

However, the arrangements are not so limited to the example processes for creation of process flows. Rather, it is contemplated that in some various arrangements, central control system 18 may be configured to implement various suitable additional or alternative processes to facilitate creation of process flows by a user.

For example, in one or more arrangements, central control system 18 may be configured to evaluate a process flow that has been created to identify if the process flow is operationally incorrect or unsafe. For example, in one or more arrangements, central control system 18 is configured to assess a process flow using a set of validation policies. Validation polices may be used for example to ensure process flow comply with certain principal operations. As one illustrative example, for safety reasons, administration for a site may set validation polices to ensure that pressing of any emergency shutdown button for any grain handling system 12 shuts down the entire process flow. As another illustrative example, as a default configuration, validation polices may ensure that no grain handling system 12 continues to move grain downstream when an error has occurred downstream. In some arrangements, central control system 18 may be configured to present a warning to a user if any validation policies are violated by a process flow. In some arrangements, central control system 18 may be configured to prevent such a process flow from executing until warnings are corrected. In some arrangements, central control system 18 may be additionally or alternatively configured to permit a user to review and override warning to permit the process flow to be executed. In some arrangements, central control system 18 may be configured to require approval by a site manager (or other authority) before warnings may be overridden.

However, the arrangements are not limited to the example processes for evaluating process flows. Rather, it is contemplated that in some various arrangements, central control system 18 may be configured to implement various suitable additional or alternative processes to evaluate process flows.

### Manual Checks by User:

In one or more arrangements, when a process flow is created a user may define manual checks to be verified by a worker at one or more location in a process flow prior to execution. When a process flow is to execute, central control system 18 may prompt a worker to perform and confirm manual checks included in the process flow prior to execution. As an illustrative example, in some arrangements, a workflow may be configured to prompt a worker to verify a grain bin door is properly closed and that the bin lid is open before executing a workflow that fills the grain bin. As another example, in some arrangements, a workflow may be configured to prompt a worker to verify that grain in a bin is the same as grain to be processed in the work flow to prevent different grains from being mixed. As another example, in some arrangements, a workflow may be configured to require a worker to look at a live image (e.g., taken by a camera inside a grain bin) and/or check the grain bin empty prior to starting a workflow that unloads the grain bin.

In some various different arrangements, central control system 18 may utilize various methods and means to prompt worker(s) to perform various checks and record conformation from the worker that the checks were completed. For example, in some arrangements, central control system 18 may provide a graphical user interface (e.g., via a smartphone app or web-portal) for a worker to select and initiate workflows and guide the worker through required checks and verifications. As another example, in some arrangements, central control system 18 may send a text message or email to a worker directing them to perform one or more checks and directing them to response with a particular message (e.g., CONFIRMED) to confirm that the check was performed. However, the arrangements are not so limited. Rather, it is contemplated that central control system 18 may be adapted to use any suitable method or means to verify that required checks are performed. Once required checks are performed, central control system 18 may cause grain handling systems 12 to start the workflow.

In addition to or in lieu of safety checks specified in a process flow, in one or more arrangements, safety checks may be specified for a particular grain handling system 12 (e.g., when the grain handling system 12 is connected to an intermediate control device 16 and configured. In one or more arrangements, if a safety check is configured for a grain handling system 12, the central control system 18 will required the safety check be performed before executing any process flow including the grain handling system 12, regardless of whether the process flow contains safety checks.

### Advance Warning System 170:

In one or more arrangements, system 10 includes an advance warning system 170. Advance warning system 170 is formed of any suitable size, shape, and design and is configured to provide advance warning to persons nearby grain handling systems 12 in a process flow prior to executing the process flow. For example, in one or more arrangements, advance warning system 170 includes one or more warning devices 172 (preferably one for each grain handling systems 12) that are controllable by central control system 18. In various some different arrangements, advance warning system 170 may include various different types of warning devices 172 including but not limited to, for example: visual warnings (e.g., rotating lights, flashing lights strobe lights, beacons, other lights, displays, actuated signs, or any other visual warning), audible warnings (bells, sirens, horns, buzzers, electric sounders, recorded messages, or any other audible warning), actuated gates or barriers, electronic messages (e.g., SMS text messaging, messaging apps, email, push notifications or other electronic communication), or any other type of warning device.

In one or more arrangements, advance warning system 170 includes one or more shutdown devices 174 to facilitate immediate shutdown of a process flow, for example by a nearby person when a warning device 172 is activated but the situation safe to operate the grain handling systems 12. In various some different arrangements, advance warning system 170 may include various different types of shutdown devices 174 including but not limited to, for example: buttons, leavers, switches, e-stops, interlocks, or any other means or method for a user to trigger shutdown of a grain handling system 12.

In one or more arrangements, central control system 18 is communicatively connected to shutdown devices 174 and is configured to immediately shutdown a grain handling system 12 associated one of the shutdown devices 174 when actuated. In one or more arrangements, central control system 18 may be configured to immediately shutdown all grain handling system 12 in a process flow when any one of the shutdown devices 174 for grain handling systems 12 in the process flow is actuated.

In one or more arrangements, system 10 may include multiple shutdown devices 174 for each grain handling systems 12, where one of the shutdown devices 174 causes central control system 18 to shutdown the associated grain handling systems 12 and the other one of the shutdown devices 174 causes central control system 18 to shut down all grain handling systems 12. The ability to shut down all grain handling systems 12 may provide faster shutdown times when an accident is observed by a worker located closer to another grain handling systems 12. That is, if an accident is observed, a worker may run to the closest grain handling system and engage the shutdown devices 174 set to shut down all grain handling systems 12.

### In Operation:

In one or more arrangements, central control system 18 is configured to permit users to create multiple different process flows that may then be loaded and executed as required to perform various different tasks that may be required in the production of grain.

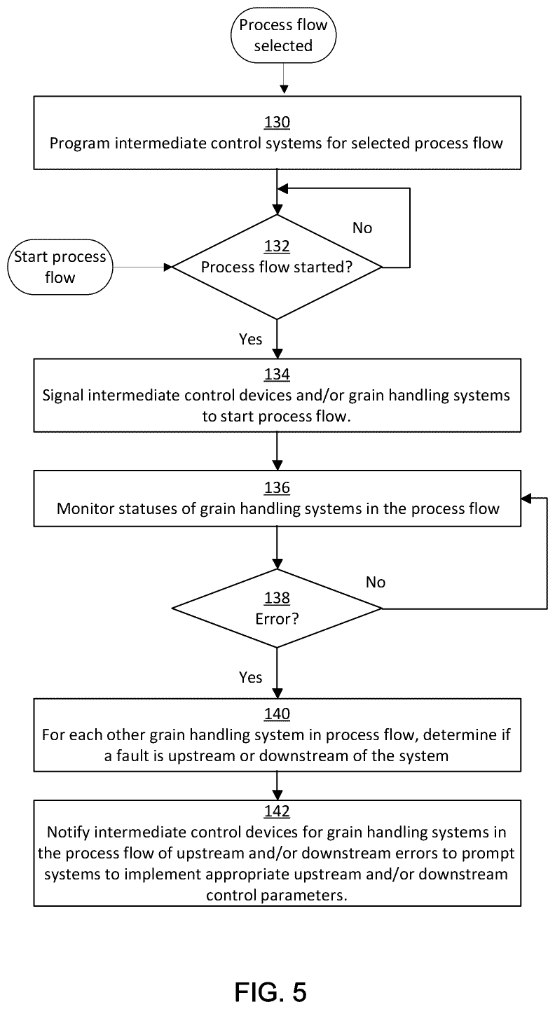

FIG. 5 shows an example process for monitoring and controlling grain handling systems 12 according to a user created process flow, in accordance with one or more arrangements. In this example, the process is initiated when a user selects a created process flow to load. At process block 130, intermediate control devices 16 for grain handling systems 12 in the selected process flow are programmed by central control system 18 to operate for grain handling systems 12 in accordance with configuration and/or settings of the process flow. In some arrangements, one or more grain handling systems 12 may additionally or alternatively be programmed at block 130 by intermediate control devices 16 and/or by central control system 18. In this example, after programming at process block 130, the process hangs at decision block 132 until a user starts the process flow. Once the process flow is initiated by the user, the process proceeds to process block 134. At process block 134, central control system 18 prompts intermediate control devices 16 and/or grain handling systems 12 to initiate the process flow. During normal operation of the process flow, central control system 18 monitors statuses of the grain handling systems 12 in the process flow at process block 136.

If the monitored status indicates an error has occurred, at decision block 138, the process proceeds to process block 140. At process block 140, for each other grain handling system 12 in the process flow, central control system 18 determines if the error occurred upstream or downstream in the process flow. At process block 142, the central control system 18 notifies the intermediate control devices 16 for grain handling system 12 in the process flow of upstream and/or downstream errors (as applicable) to prompt the grain handling system 12 to implement the appropriate control parameters for upstream and/or downstream errors (e.g., as previously programmed for the process flow at process block 130). However, the arrangements are not so limited. Rather, it is contemplated that in some arrangements, central control system 18 may be configured to dynamically issue commands to intermediate control devices 16 and/or grain handling system 12 based on statuses of the systems rather than preprograming intermediate control devices 16 and/or grain handling system 12 (e.g., as performed at process block 130). Additionally or alternatively, in some arrangements, central control system 18 may be configured to preprogram intermediate control devices 16 and/or grain handling system 12 to implement control parameters independently but may also issue some commands to intermediate control devices 16 and/or grain handling system 12 dynamically during operation.

While some arrangements, may be primarily described with reference to central control system 18 indirectly monitoring, controlling, and/or communicating with grain handling systems 12 indirectly via intermediate control devices 16, the arrangements are not so limited. Rather, it is contemplated that in some arrangements, central control system 18 may be configured to communicate with and/or program one or more grain handling systems 12 without an intermediate control device 16 through one or more data networks.

### Not Limited to Mitigating Upstream/Downstream Errors:

For ease of explanation, some various arrangements may be described as determining appropriate control parameters based on whether error occurs upstream of, downstream of, or locally within each system. However, the arrangements are not so limited. Rather, it is contemplated that in some various arrangements, selection of control parameters for handling errors in a process flow may be based on any number of factors, sensor states, and/or logic functions.

Furthermore, while one or more arrangements may be primarily described with reference to implementing control parameters in response to errors specified by error parameters, the arrangements are not so limited. Rather, it is contemplated that error parameters may be used to specify states or situations that may not conventionally be considered errors. For example, a created process flow may define error parameters specifying sensor states/thresholds within a normal operating/process range. For example, in one or more arrangements error parameters may specify upper and lower thresholds for a temperature sensor in a grain bin to may be used indicate when grain temperature fall outside of a most preferred temperature range.

As another example, in some arrangements error parameters for a process flow may specify flow rates for one or more grain handling systems 12. Control parameters of the process flow may be configured to cause central control system 18 to adjust speed of one or more grain handling systems 12 according to flow rates specified by the error parameters to reduce the chances that grain handling systems 12 may become plugged and/or attempt to automatically unplug a plugged grain handling system 12.

### Illustrative Examples

Generally speaking, when a significant error occurs, in most situations it is generally desirable to immediately shutdown upstream grain handling systems 12, to pause flow of grain to the system in error, and continue to run downstream grain handling systems 12 for a cleanout period to move the downstream grain to the destination (e.g. grain bin, truck, etc.) unless an emergency stop is initiated. However, the preferred operations to perform in a process flow in response to errors can vary greatly between different grain handling sites depending on what equipment is used, what grain is being processed, what tasks are being performed in the process flow, and the particular priorities of the operator. There are any number of different situations that an operator may wish to operate grain handling systems 12 differently to address the needs and/or preferences of a particular grain handling site.

A one illustrative example, unless an emergency stop is initiated, in some grain handling sites, it may be desirable for certain types of upstream grain conveyors to continue running until cleanout is complete. For example, some bucket type grain conveyors are designed to be started up and running prior to being provided grain. If stopped while fully loaded, the motor of the bucket type grain conveyor may not have sufficient torque to restart operation without being overloaded. Similarly, if air type conveyors are stopped while grain is being transported, grain in the conveyor may fall down and may form a clog in the lower end of some conveyors. For such situations, an operator of a grain handling site may choose to configure control parameters of a process flow to stop an auger feeding the grain conveyor and continue operation of the grain conveyor for an unload period even if the next grain handling system 12 following the conveyor is full, disabled, and/or shutdown.

As another example, it may be desirable to shut down a downstream grain drier while it is still filled with dried grain inside so it may be more easily restarted as a later time. For instance, some grain dryers need to be filled with grain in order to control grain flow and drying conditions in the grain dryer. In such grain dryers, care is taken to ensure that the initial grain input while filling has been adequately dried to a shelf stable state for storage. Otherwise, if such grain retains too much moisture, there is risk they moist portion of grain may spoil and contaminate a large portion of grain in a grain bin. Accordingly, some grain dryers may have longer startup procedures to get to the state where they are filled with grain where the grain at the output of the grain dryer has been properly dried.

In such case, when an error occurs upstream of the grain dryer, the process flow may be configured to, for example, continue running grain handling systems 12 downstream of the error until sensors (e.g., at intake of the grain dryer) indicate that conveyors are no longer providing grain to the grain dryer. At such time, an auger conveyer that removes grain from the dryer may be shut down and the grain dryer may be switched to an orderly shutdown mode, where remaining grain in the dryer is dried in place for a period of time so it is shelf stable within the grain dryer. Such process flow may be useful for example when the harvesting process cannot maintain a constant flow of grain from a wet grain bin to the dryer.

### User Interfaces 36:

In one or more arrangements, central control system 18 is configured to provide one or more user interfaces configured to facilitate the installation and configuration and/or programming of intermediate control devices 16 and/or grain handling systems 12.

User interface 36 provided by central control system 18 may be formed of any suitable size, shape, and design, and/or technology and is configured to permit end users to interact with central control system 18 to facilitate input, access to, and processing of relevant data to facilitate installation and configuration and/or programming of intermediate control devices 16 and/or grain handling systems 12.

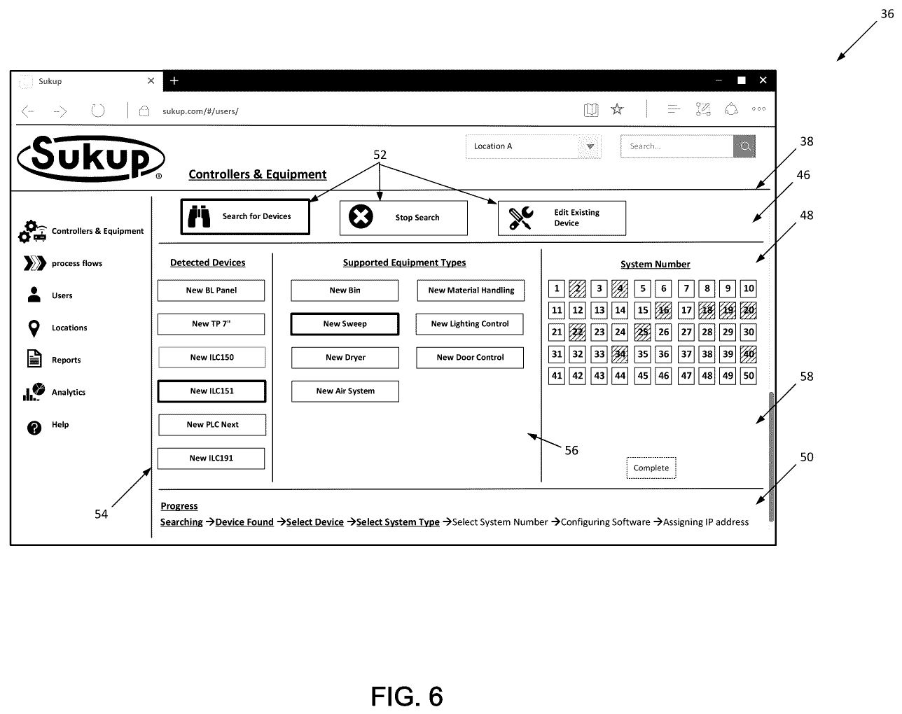

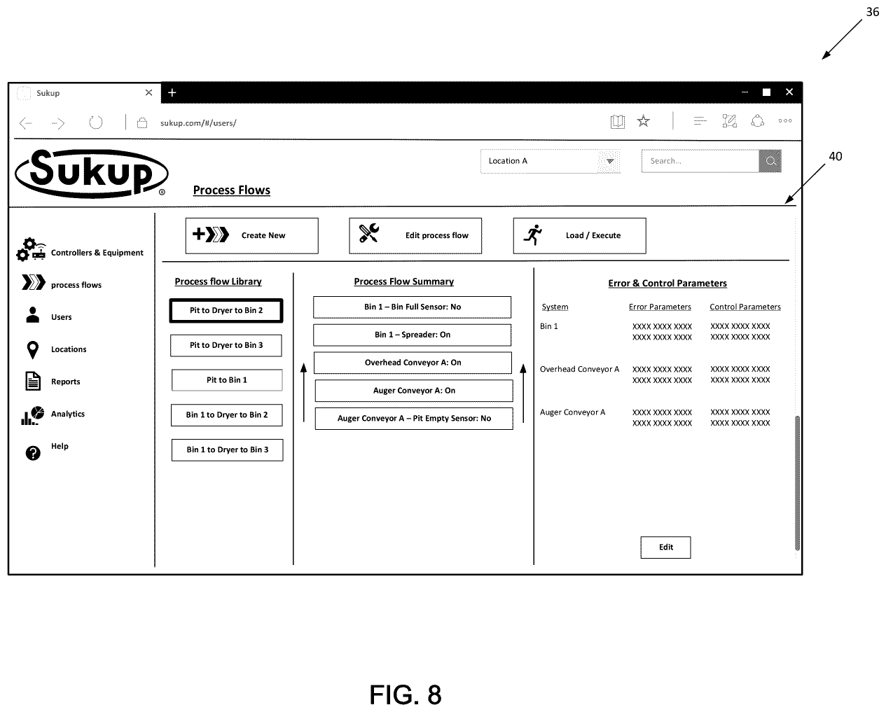

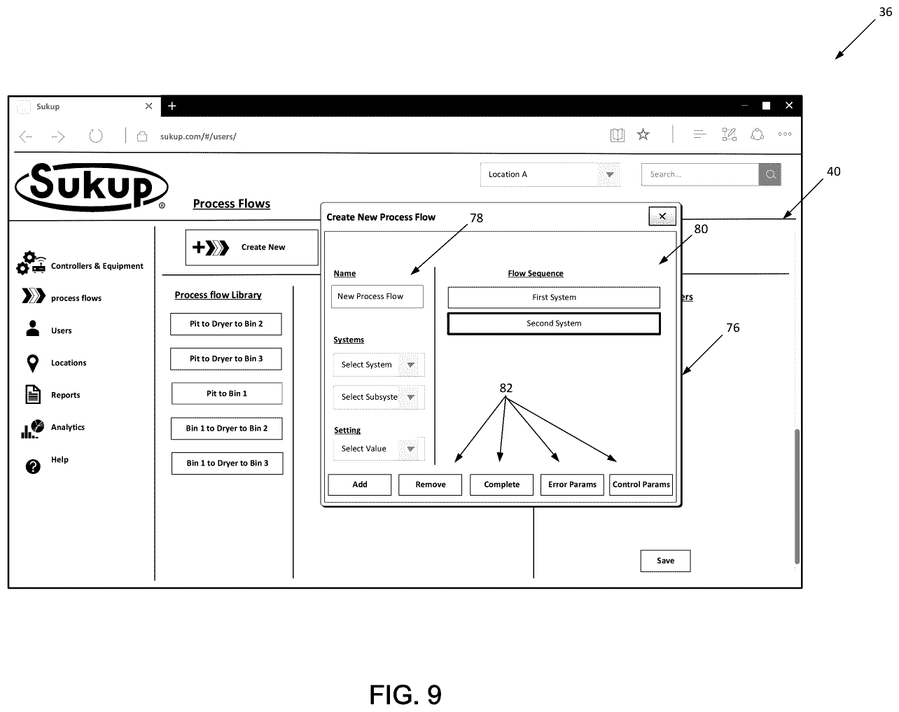

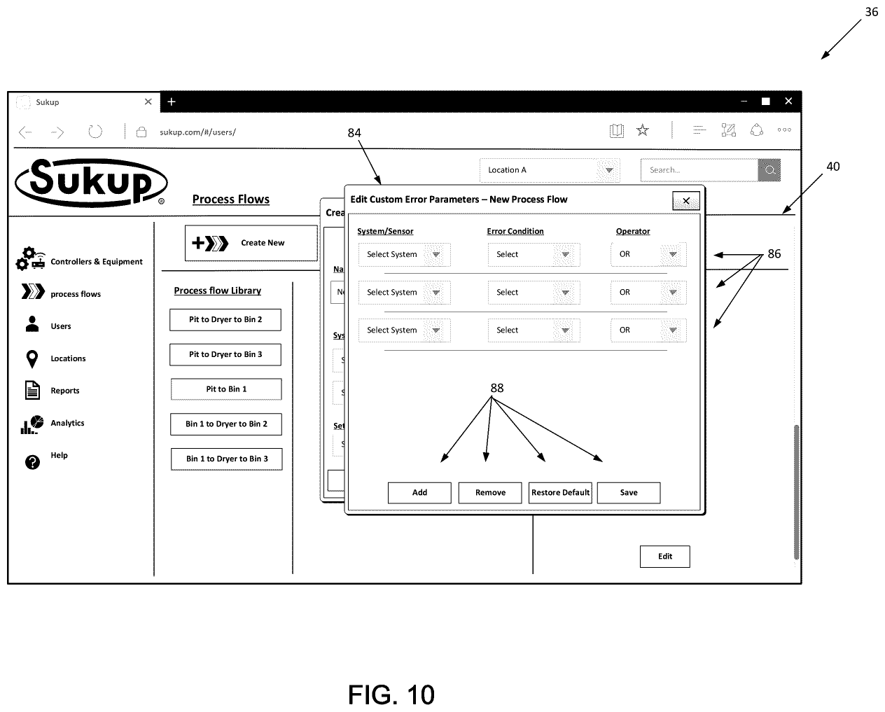

FIGS. 6-12 show screen shots of an example user interface 36, in accordance with one or more arrangements. In this example arrangement, the user interface 36 provides a controllers & equipment dashboard 38 and a process flow dashboard 40, among other dashboards and interfaces.

FIG. 6 shows a screen shot of the example user interface 36 with controllers & equipment dashboard 38 (or simply dashboard 38) displayed. Dashboard 38 is formed of any suitable size, shape, and design, and/or technology and is configured to permit end users to facilitate installation and configuration and/or programming of intermediate control devices 16 and/or grain handling systems 12.

In this example application, the dashboard 38 includes an upper panel 46 having buttons 52 to facilitate searching for new devices (e.g., intermediate control devices 16) and/or configuring existing devices. In this example arrangement, after connecting a new device to the network, a user may use a “search for devices” button to initiate search for new devices. In this example, intermediate control devices 16 found in the search are listed in a left column 54 of a center panel 48. Upon a user selecting one of the intermediate control devices 16, compatible types and/or models of equipment that can be controlled by the selected intermediate control devices 16 are presented in a center column 56 of center panel 48. In this example arrangement, the user then selects the type/model of grain handling system 12 to be controlled in center column 56 and selects an identification number to assign to the selected system in a right column 58 of the center panel 48. In this example, identification number that have already been assigned are graphically distinguished from non-assigned numbers (e.g., by color or marking). After assigning the identification number to the system, the use may select complete to prompt the central control system 18 to configure software for and assign an IP address to the intermediate control device 16, among other tasks that may be required for installation. In this example arrangement, the dashboard 38 includes a lower panel 50 where progress of installation process is shown.

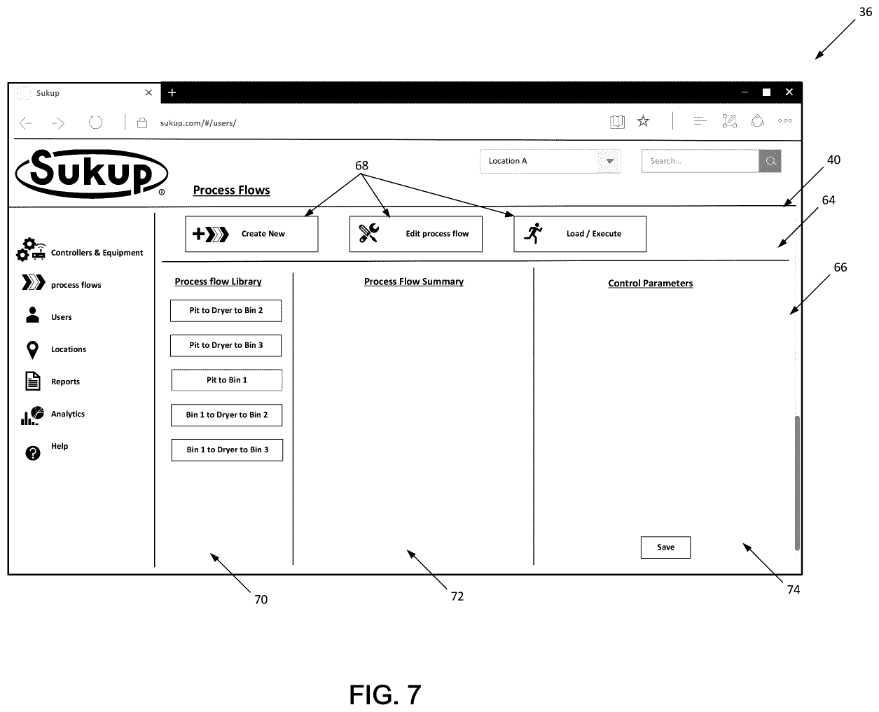

FIGS. 7-12 show screen shots of the example user interface 36 with process flow dashboard 40 (or simply dashboard 40) displayed. Dashboard 40 is formed of any suitable size, shape, and design, and/or technology and is configured to permit end users to create process flows for operation of select group of grain handling systems 12 to perform desired tasks.

In this example user interface 36, the dashboard 40 includes a lower panel 66 for display of process flows. In this example, a library of previously created process flows is listed in a left column 70 of lower panel 66. Upon a user selecting one of the process flows, a summary of the process flow is displayed in a center column 72 of lower panel 66. In this illustrative example, the process flow summary illustrates a sequence of grain handling systems 12 in the process flow and a high level description of the intended operation of such grain handling systems 12 in the process flow. In this example, lower panel 66 also includes a right column 74 configured to display a summary of error parameters (indicating criteria for detecting when errors occur) and control parameters (indicating actions to be performed by the grain handling systems 12 when errors occur) for the selected process flow.

In this example arrangement, the dashboard 40 includes an upper panel 64 having buttons 68 to facilitate creation of a new process flow, editing of a selected process flow, or loading and execution of a selected process flow.

In this example arrangement, when the user selects to create a new process flow, a separate interface window 76 is presented to facilitate creation of a new process flow. In this illustrative example, interface window 76 includes fields in a left column 78 to facilitate naming of the process flow and selection of systems and settings therefore to be added to the process flow. In this illustrative example, interface window 76 is configured to display a sequence of systems as added to the process flow in a right column 80. In this illustrative example, interface window 76 includes a number of control buttons 82 along a lower edge of the interface window 76 to facilitate addition of selected systems in left column 78 to the process flow, removal of systems from the current process flow, configuration of error parameters and/or control parameters for the systems in the process flow. In one or more arrangements, the software is configured to create the process flow using default error parameters and/or control parameters for the systems unless different error parameters and/or control parameters are set by the user.

In the example arrangement shown, if a user selects an “error parameters” button 82, a new interface window 84 is presented to facilitate customization of error parameters for use with the process flow. In this example, interface window 84 is configured to present selection fields for a user to define one or more sets of customized error parameters 86. In this example, interface window 84 is includes drop down interfaces in each set of error parameters 86 to facilitate selection of a system or sensor and a condition of the selected system/sensor that is indicated of error. In this example, a user may define several sets of error parameters 86 and specify logical operators (e.g., and/or) to connect the sets of sets of error parameters 86 into a logic function indicative of when an error has occurred. In this example, a user may add or remove sets of error parameters 86 using buttons 88 positioned at a lower edge of interface window 84.

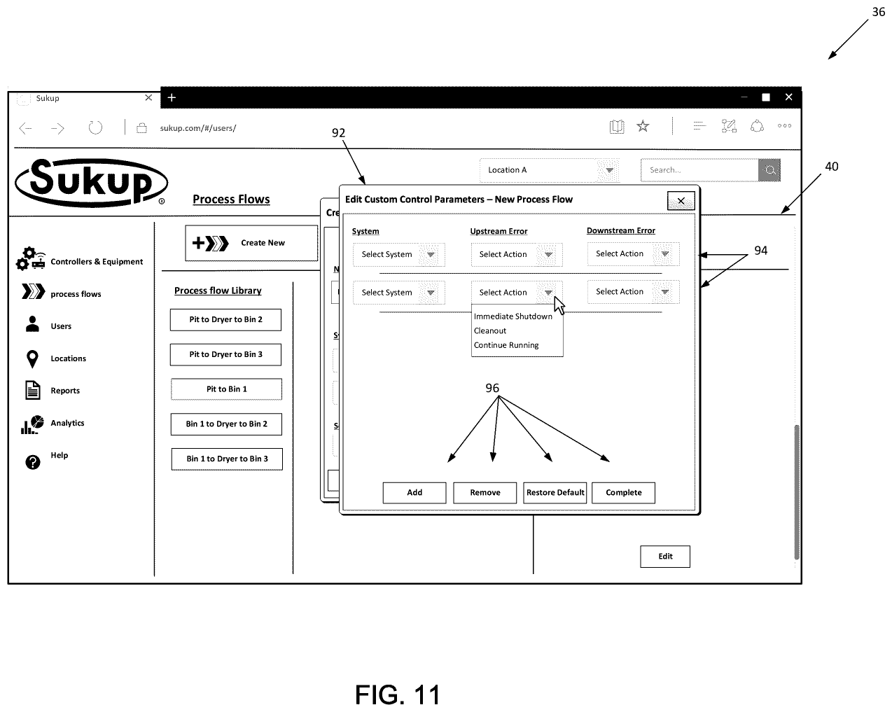

Referring back to the interface window 76 for creation of process flow, in this example, if a user selects “control parameters” button 82, a new interface window 92 is presented to facilitate customization of control parameters for use with the process flow. FIG. 11 shows such an example interface window 92, in accordance with one or more arrangements. In this example, interface window 92 is configured to present selection fields for a user to define one or more sets of customized control parameters 94. In this example, a user may add or remove sets of control parameters 94 using buttons 96 positioned at a lower edge of interface window 92. In this example, interface window 92 is includes drop down interfaces in each set of control parameters 94 to facilitate selection of a system, selection of an action to be performed if error occurs upstream of the system in the process flow, and selection of an action to be performed if error occurs downstream of the system in the process flow. In this example, the interface window 92 is configured to permit a user to select as a desired action 1) for immediate shutdown of the system, 2) for the system to run for a period of time to cleanout grain from the system, or 3) for the system to continue running. However, the arrangements are not so limited. Rather, it is contemplated that in some various arrangements, central control system 18 may permit users to select desired actions from various additional or alternative actions. Moreover, it is contemplated that in some various arrangements, central control system 18 may permit users to specify custom actions to be performed in response to upstream errors and/or downstream errors.

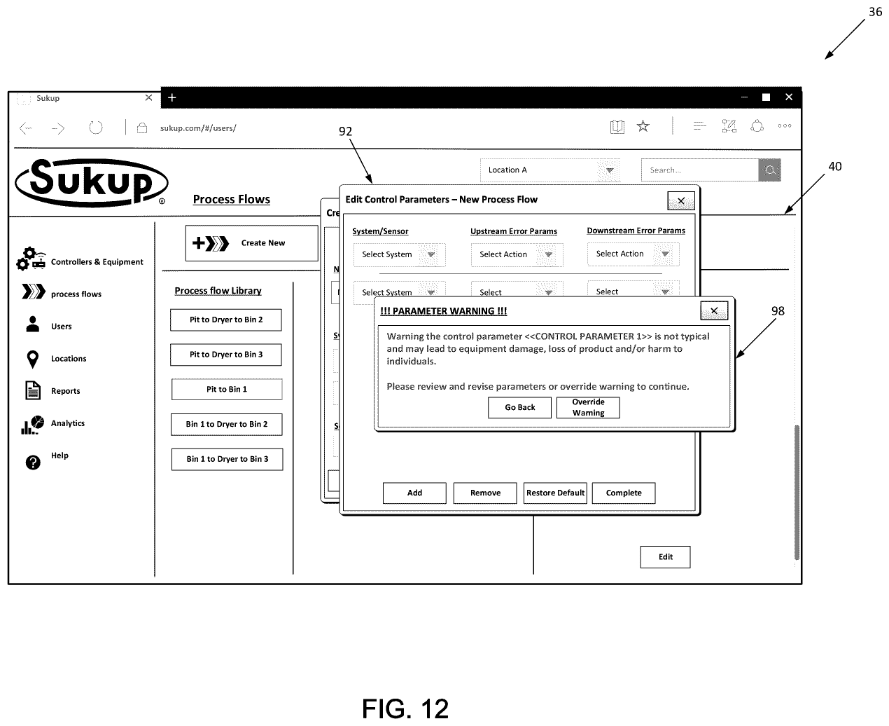

In one or more arrangements, central control system 18 is configured to evaluate control parameters once completed by a user to help ensure that the specified control parameters will not result in additional damage to equipment, loss of grain, or harm to workers. In one or more arrangements, user interface 36 is configured to present a pop-up window 98 with a warning if central control system 18 determines that the control parameters may result in additional damage to equipment, loss of grain, or harm to workers. FIG. 12 shows an example pop-up window 98 that may be presented in one or more arrangements. In this illustrative example, the pop-up window 98 presents a warning that a particular control parameter is atypical and may lead to damage to equipment, loss of grain, or harm to workers. In this illustrative example, the pop-up window 98 prompt the user to go back and review and correct the identified control parameter or to override the warning to proceed with the identified control parameter as is.

However, the arrangements are not so limited to the example user interfaces 36 discussed herein. Rather, it is contemplated that in various arrangements, user interfaces 36 may include any number of different dashboards and/or interface windows with various additional or alternative information in various different arrangements and/or having various additional or alternative means or methods for user selection and/or interaction.

### Custom Site Builder:

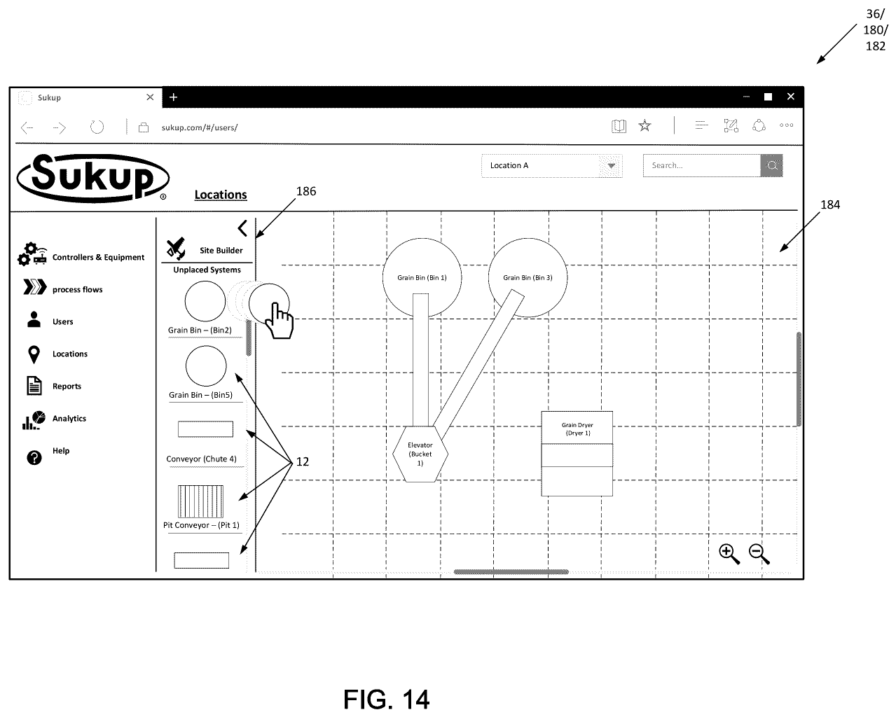

In one or more arrangements, user interfaces 36 includes a custom site builder tool 180 to facilitate graphical arrangement of grain handling systems 12 and/or other equipment as they are deployed on site. Such graphical arrangement may provide easy reference for selection of grain handling systems 12 (e.g., when creating process flows) in comparison to relying on naming convention to identify different grain handling systems. FIG. 14 shows an example interface providing custom site builder tool 180, in accordance with one or more arrangements. In this example arrangement, custom site builder tool 180 includes a main panel 184 having a grid layout on which a user may place grain handling systems 12 that have been added in the system 10. In this example arrangement, custom site builder tool 180 includes a side panel 186 having a scrollable list of grain handling systems 12 that have been added but have not been placed on the grid layout in main panel 184. In this example arrangement, a user may simply drag and drop grain handling systems 12 from side panel 186 to the grid layout in main panel 184. Once placed, a user may resize and/or customize the grain handling system 12 (e.g., by right clicking on the grain handling system 12 to view available options and/or actions). In this manner, a user may easily create and configured a layout of a site.

However, the arrangements are not so limited. Rather, it is contemplated that in some various different arrangements custom site builder tool 180 may utilize various means and/or methods to facilitate creation of a layout of the grain handling systems 12 on a site.

### Data Processing System 160:

Various blocks, modules, or other circuits may be used to implement central control system 18, intermediate control devices 16, or other components, operations and activities described herein and/or shown in the figures. In these contexts, a “block” (also sometimes “logic circuit,” “control circuit,” “processing circuit,” “server,” “module,” “data processing system” or “system”) is a circuit specifically configured and arranged to carry out one or more of these or related operations/activities. For example, such circuits may be discreet logic circuits or programmable logic circuits configured and arranged for implementing these operations/activities, as shown in the figures and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, tablet, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain aspects are directed to a computer program product (e.g., nonvolatile memory device), which includes a machine or computer-readable medium having stored thereon instructions which may be executed by a computer (or other electronic device) to perform these operations/activities.

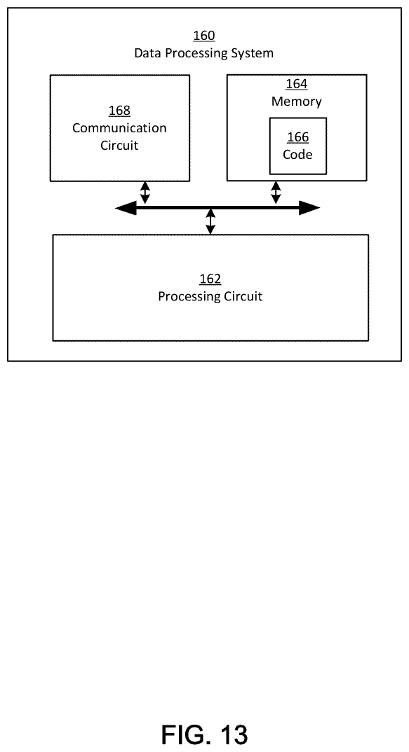

FIG. 13 shows an example data processing system 160 that may be used to implement systems, circuits, components, and/or processes of central control system 18 and/or intermediate control devices 16, in accordance with one or more arrangements. Data processing system 160 is formed of any suitable size, shape, design, and/or technology and is configured to carry out the one or more of these or related operations/activities described herein. In the arrangement shown, as one example, data processing system 160 includes a processing circuit 162 and memory 164 having software code 166 or instructions that facilitates the processing and/or display of information, and a communication circuit 168, among other components.

Processing circuit 162 may be any computing device that receives and processes information and outputs commands according to software code 166 or instructions stored in memory 164. Memory 164 may be any form of information storage such as flash memory, ram memory, dram memory, a hard drive, or any other form of memory. Processing circuit 162 and memory 164 may be formed of a single combined unit. Alternatively, processing circuit 162 and memory 164 may be formed of separate but electrically connected components. Alternatively, processing circuit 162 and memory 164 may each be formed of multiple separate but electrically connected components.

Software code 166 or instructions is any form of information or rules that direct processing circuit 162 how to receive, interpret, and respond to information to operate as described herein. Software code 166 or instructions is stored in memory 164 and accessible to processing circuit 162. As an illustrative example, in one or more arrangements, software code or instructions may configure processing circuit 162 to interact with users via a user interface and perform various processes in response to user input.

Communication circuit 168 is formed of any suitable size, shape, design, and/or technology and is configured to facilitate communication with various other components of system 10 (as may be applicable). In one or more arrangements, as one example, communication circuit 168 includes a transceiver circuit and an antenna. A transceiver is any electronic device that facilitates two-way communication, that is, the delivery of information between data processing system 160 and other components of the system 10. An antenna is any device that is configured to receive wireless signals from over-the-air communication and/or transmit wireless signals in over-the-air communication. In an example arrangement, a transceiver of communication circuit 168 is connected with a respective antenna, which may be a monopole antenna, dipole antenna, a loop antenna, a fractal antenna, or any other form of an antenna, to facilitate transmission and/or reception of signals in the form of electromagnetic radio frequencies. Additionally or alternatively, the transceiver of communication circuit 168 may be configured to communicate over a wired communication channel.

In various arrangements, communication circuit 168 may be configured to communicate with various components of system 10 using various wired and/or wireless communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, Ultra Wideband (UWB), 802.15.4/ZigBee, ZWave, GSM/EDGE, UMTS/HSPA+/HSDPA, CDMA, LTE, 4G, 5G, FM/VHF/UHF networks, and/or any other communication protocol, technology or network.

Although in some arrangements, various circuits, components, systems, programs, or processes of central control system 18, intermediate control devices 16, or other portions of system 10 may be primary described or shown as being implemented together on the same system, machine, network, program or process, the arrangements are not so limited. Rather it is contemplated that in some arrangements, such components, systems, programs, or processes of central control system 18, intermediate control devices 16 or other portions go system 10 may be implemented separately on by separate processes or programs and/or on separate circuits, systems, and/or components on the same bus or network or communicatively connected between different networks. Conversely, although in some arrangements, various circuits, components, systems, programs, or processes of central control system 18, intermediate control devices 16, or other portions of system 10 may be primary described or shown as being implemented separately, the arrangements are not so limited. Rather, it is contemplated that such components, systems, programs, or processes of central control system 18, intermediate control devices 16, and/or other portions of system 10 may be implemented together by the same processes or program and/or on the same circuit, system, and/or component of system 10.

### Adaptive Control System 200:

In some arrangements, system 10 includes an adaptive control system 200 configured to facilitate adaptive control of grain handling systems 12 during operation. Adaptive control system 200 is formed of any suitable size, shape, and design and is configured to communicate with grain handling systems 12 directly or indirectly (e.g., via intermediate control devices 16) to facilitate monitoring and/or adjustment of one or more operational control settings (e.g., operating speed, throughput/metering speed, temperature, airflow, grain density and/or/viscosity, and/or any other controllable parameter) of grain handling systems 12 to adjust operation in a process flow for one or more performance parameters 210 selected by a user (e.g., throughput, power/fuel usage, grain quality, and/or equipment longevity as some non-limiting examples).

In some various arrangements, adaptive control system 200 may be configured to automatically adjust various operational control settings during operation to facilitate improvement of one or more performance parameters 210. In some various arrangements, adaptive control system 200 may be configured to dynamically adjust various operational control settings during operation to adapt to changes in operating conditions (e.g., changes in temperature, humidity, grain moisture content, and/or other environmental conditions).

In some various arrangements, adaptive control system 200 may be a standalone system or may be integrated with central control system 18, intermediate control devices 16, and/or other components of system 10. For ease of explanation, arrangements may be primarily described with reference to an adaptive control system 200 that is implemented as part of central control system 18. For example, in one or arrangements, adaptive control system 200 is implemented by one or more adaptive control processes (e.g., executed by data processing system 160 of central control system 18).

However, the arrangements are not so limited. Rather, it is contemplated that in some various arrangements, various processes of adaptive control system 200 may be performed by one or a combination of central control system 18, intermediate control devices 16, and/or any other component of system 10 or system communicatively connected to system 10. Furthermore, adaptive control system 200 is not limited to use with the particular arrangements of system 10 disclosed herein. Rather, it is contemplated that in some arrangements, system 10 may utilize adaptive control system 200 with one or more features or functions of central control system 18, intermediate control devices 16, and/or other components of system 10 omitted. Moreover, is contemplated that adaptive control system 200 may be utilized in various other systems and/or arrangements, for controlling operation of grain handling systems 12.

### Optimization of Performance Parameters 210:

In one or more arrangements, adaptive control system 200 may be configured to adjust one or more control settings to control operation of grain handling systems 12 to optimize various performance parameters 210. Some example performance parameters 210 may include but are not limited to, for example, throughput, power/fuel usage, grain quality, and/or equipment longevity, to name a few. In some various arrangements, performance parameters 210 may be optimized for an entire process flow or for one or more individual grain handling systems 12 in a process flow.

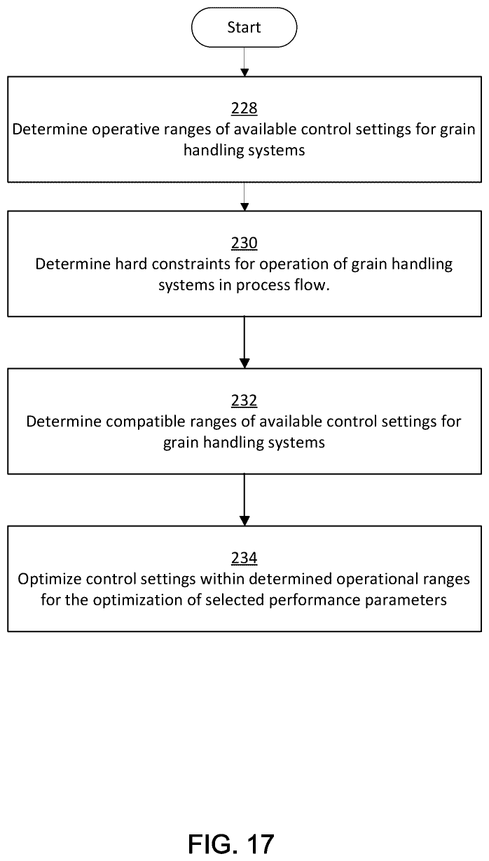

In some various arrangements, adaptive control system 200 may be configured to optimize operation of grain handling systems 12 using various different processes. FIG. 17 shows an example process for optimization operation of grain handling systems 12 for a set of performance parameters 210, in accordance with one or more arrangements.

In this example process, adaptive control system 200 first determines operative ranges of control settings 212 for grain handling systems 12 at process block 228. Control settings 212 may include various controllable variables related to operation of grain handling systems 12 including but not limited to, for example, operating speed/power level, temperature, pressure, duration of continuous operation, or any other parameter relating to operation of a grain handling system. At process block 230, adaptive control system 200 determines constraints 214 (if any) on operation of grain handling systems 12 in the process flow (also referred to operating constraints 214). Operating constraints 214 may include, for example, various different limitations on operation of grain handling systems 12 (e.g., limits on range of control settings). In some various arrangements, operating constraints 214 may be specified, for example, by manufacturers of grain handling system 12 and/or may be custom defined by users). Additionally or alternatively, some various arrangements, some operating constraints 214 may be dictated by, for example, target grain characteristics, source grain characteristics, and/or environmental conditions. As one illustrative example, in some arrangements, moisture content of grain, humidity levels, and air temperature may limit the ranges of speed and/or temperature that a grain dryer can be operated to produce grain with a target moisture content.

After determining operating constraints 214 in this example, the process proceeds to process block 232. At process block 232, adaptive control system 200 determines compatible ranges of control settings 212 for grain handling systems 12 in the process flow. In other words, adaptive control system 200 determines ranges that control settings 212 for grain handling systems 12 may be set to while satisfying the operating constraints 214. As an illustrative example, a hypothetical grain handling system 12 may have a manufacturer specified operating constraint 214 recommending that the grain handling system be operated in a range of 1000-4000 RPM and also a user specified operating constraint 214 that the grain handling system 12 be operated at a speed greater than 2000 RPM. Assuming there are no other operating constraints 214 for this hypothetical grain handling system 12, the operational range of the operating speed control setting 212 would be 2000-4000 RPM. After operational ranges of control settings are determined in this example, the process proceeds to process block 234, where adaptive control system 200 determines control setting 212 settings within the determined operational ranges for optimization of selected performance parameters.

### Illustrative Example—Optimization of Throughput

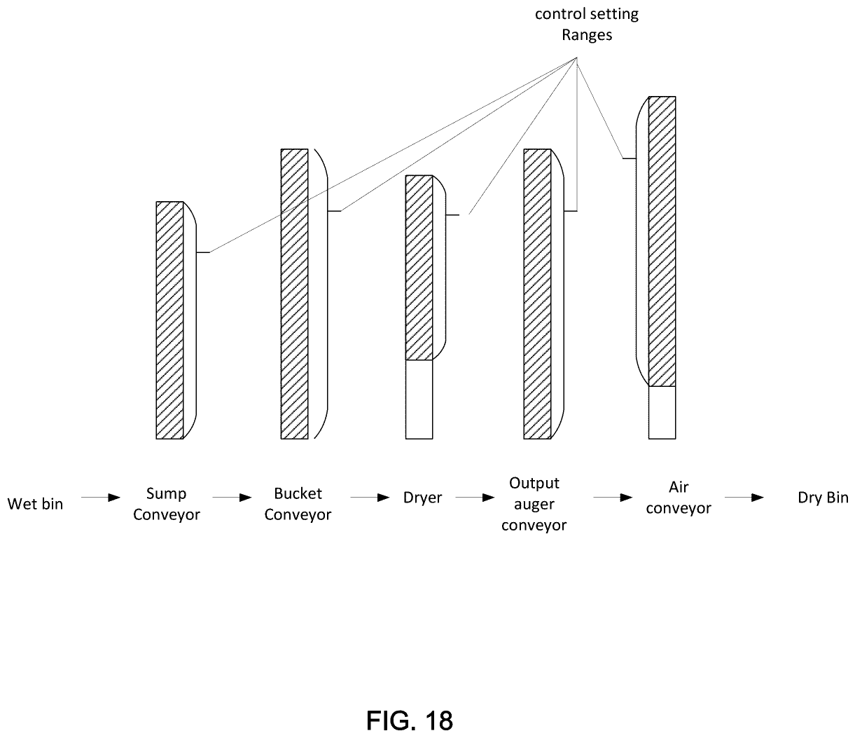

As one illustrative example, in one or more arrangements, adaptive control system 200 may be configured to optimize operation of grain handling systems 12 in a process flow to maximize throughput of grain. FIG. 18 shows a graphical depiction of individual operating speed ranges for five grain handling systems 12 of a hypothetical process flow for moving wet grain from a wet storage grain bin through a grain dryer and into a bin for storage. In this example, the process flow includes a sump conveyor to remove grain from the wet bin, a bucket conveyor to move wet grain from the sump conveyor, a grain dryer configured to receive and dry grain from the bucket conveyor, an output auger conveyor to move dry grain from the grain dryer, and an air conveyor to move the dry grain to a dry grain bin for storage.

In this example, potential operating speed of each grain handling system 12 is represented on a respective vertical bar, with operation speed range represented by diagonal hashed portions.

In this hypothetical example, the operating speed of each grain handling system 12 is variably adjustable and grain drier and air conveyor have minimum operating speed.

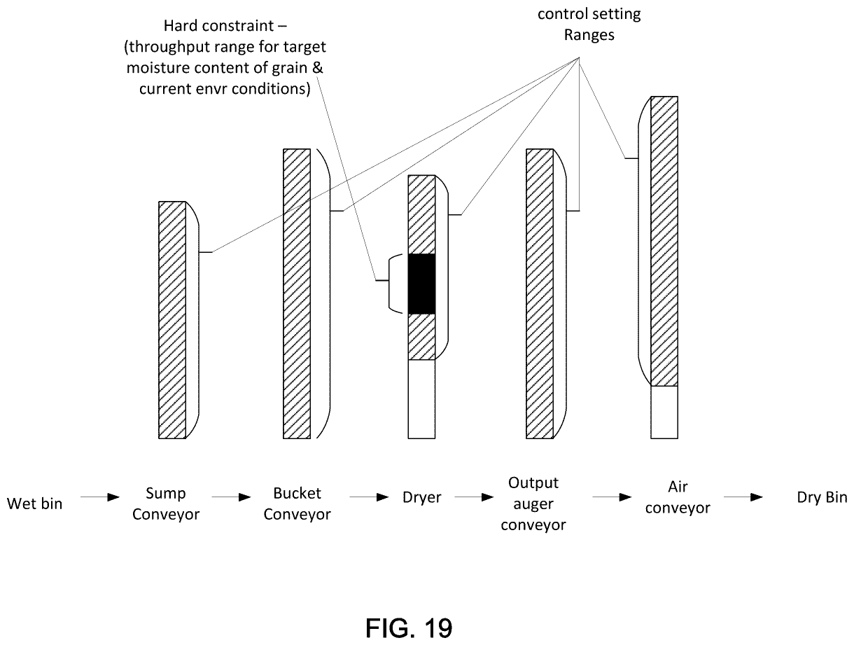

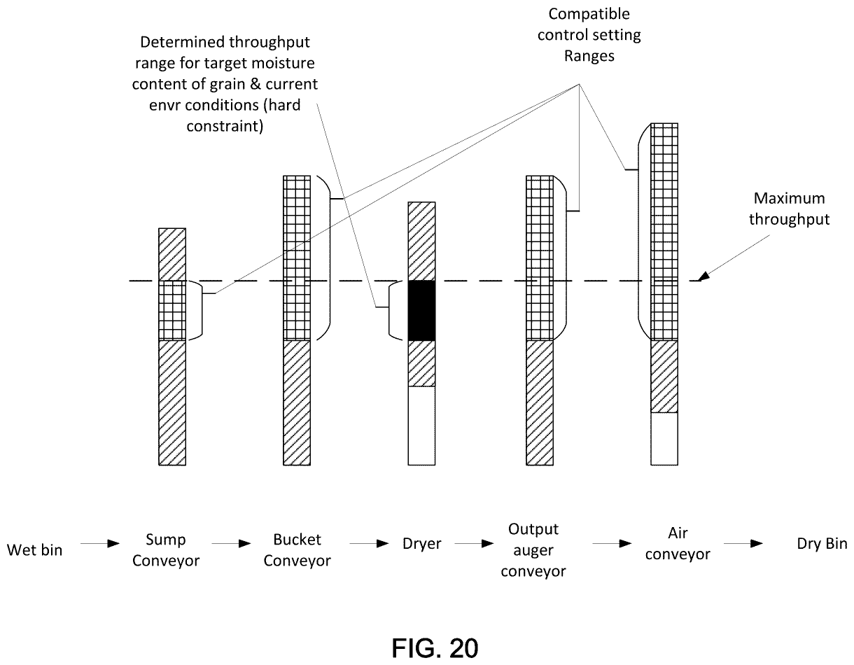

FIG. 19 shows the graph of FIG. 18 with a hard constraint depicted (illustrated as solid black) on the operating speed for the grain dryer. For instance, adaptive control system 200 may determine that this limited range on the operating speed of the grain dryer is required in order to dry grain to a target moisture. FIG. 20 shows the graph of FIG. 19 with compatible control settings (e.g., compatible with the hard constraint on operating speed of the grain drier) shown for other grain handling systems 12 in the process flow. In this example, compatible ranges of the control setting 212 (i.e., speed) are shown with cross hatches. In this illustrative example, the throughput speed of the input source for the process flow (i.e., sump conveyor) should match the throughput of the grain dryers. In this example, other grain handling systems 12 in the process flow (e.g., bucket conveyor, output auger conveyor, and air conveyor) must operate as a throughput speed at least the same as the grain drier but may be run at a faster speed if desired. From this, maximum throughput can be determined to be the highest compatible through the throughput speed that can be supported by all grain handling systems 12 in the process flow. However, the arrangements are not so limited. Rather, it is contemplated that in some various arrangements adaptive control system 200 may be configured to additional or alternatively optimize operation for various different performance parameters 210 and/or with various different operational constraints 214. Moreover, it is contemplated that in some various arrangements adaptive control system 200 may be configured to perform optimization for performance parameters 210 using various additional or alternative processes to those example processes described herein.

### Dynamic Optimization During Operation:

In some arrangements, control settings are assessed and optimized before operation of a process flow. Additionally or alternatively, in one or more arrangements, adaptive control system 200 may be configured to dynamically adjust one or more control settings 212 during operation of a process flow to update optimization (e.g., to adapt to changing operating conditions. For example, drying, transportation, and/or other processing of grain may be affected by changes in various variables including but not limited to environmental conditions (e.g., temperature, humidity, etc.) and input grain characteristics (grain size, moisture content, etc.).

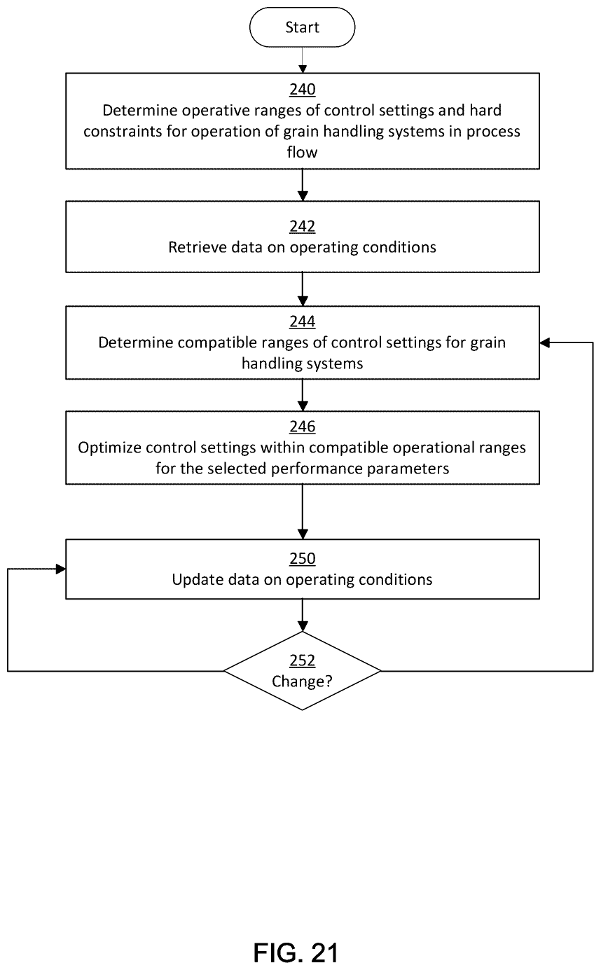

FIG. 21 shows an example process for dynamic optimization of a process flow for one or more performance parameters, in accordance with one or more arrangements. At process block 240, operative ranges of control settings 212 and operative constraints 214 (if any) are determined for grain handling systems 12 in the process flow. At process block 242, data on operating conditions related to the process flow are determined. At process block 244, compatible ranges of control settings are determined for grain handling systems 12 in the process flow. At process block 246, control settings for grain handling systems 12 in the process flow are optimized for selected performance parameters.

In this example, the process continuously/periodically updates operating conditions at process block 250 and loops at decision block 252 until a change in operating conditions occurs. When a change in operating conditions occurs, the process is directed from decision block 252 back to process block 244, where compatible ranges of control settings are updated at process block 244, control settings are reoptimized at process block 246, and settings of control settings are updated at process block 248. The process continues in this manner under operation of the process flow is stopped or otherwise interrupted.

However, the arrangements are not so limited. Rather, it is contemplated that in some various arrangements adaptive control system 200 may be configured to perform dynamic optimization for performance parameters 210 using various additional or alternative processes to those example processes described herein.

### Optimization of Secondary Performance Parameters:

In one or more arrangements, adaptive control system 200 may be configured to additionally optimize grain handling systems 12 for one or more secondary performance parameters 216. As an illustrative example, in one or more arrangements, adaptive control system 200 may be configured to set operating speed of grain handling systems 12 to maximize throughput (as a primary performance parameter 210 for optimization). However, maximum throughput in a process flow is limited by the lowest throughput grain handling system (or bottleneck), which must run at its highest throughput speed. However, other systems may be capable at running at a range of higher speeds, while meeting the maximum throughput requirement. By adjusting operation of such systems within these ranges, it may be possible to optimize performance for one or more secondary performance parameters 210. For example, in some instances, it may be desirable to run a grain transporter at a higher speed than minimally required to or increase fluidity of grain and/or reduce engine strain (e.g., to optimize lifespan of an ageing grain handling system). Conversely, in some instances, it may be desirable to run some grain handling systems 12 at a particular speed within the operational range to reduce power consumption, minimize damage to grain, and/or avoid grain blockages, among other operational objectives.

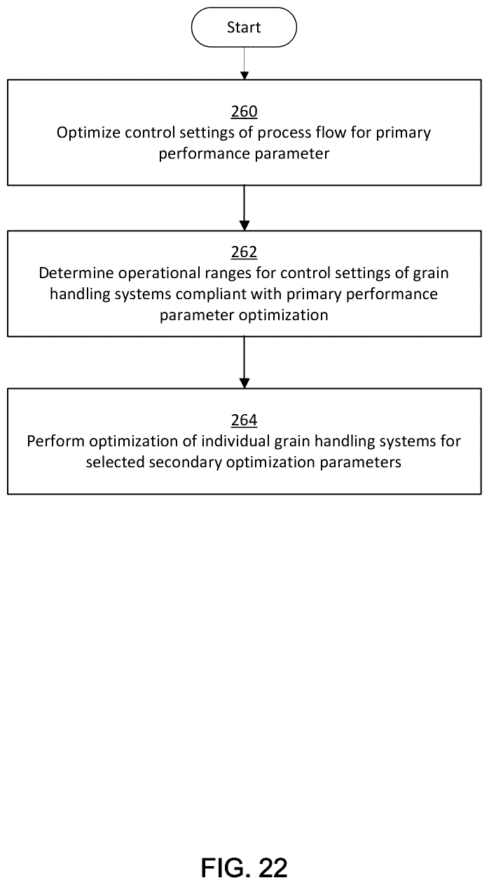

FIG. 22 shows an example high level process for optimizing a process flow for primary and secondary performance parameters, in accordance with one or more arrangements. In this example arrangement, control settings for a process flow are optimized at process block 262 for a primary performance parameter 210 (e.g., as discussed with reference to FIG. 17 and FIG. 21). At process block 262, operational ranges for control settings of grain handling systems 12 in the process flow that are compatible with the primary performance parameter optimization are determined. At process block 264, control settings are optimized (within the determined compatible ranges) for selected secondary performance parameters.

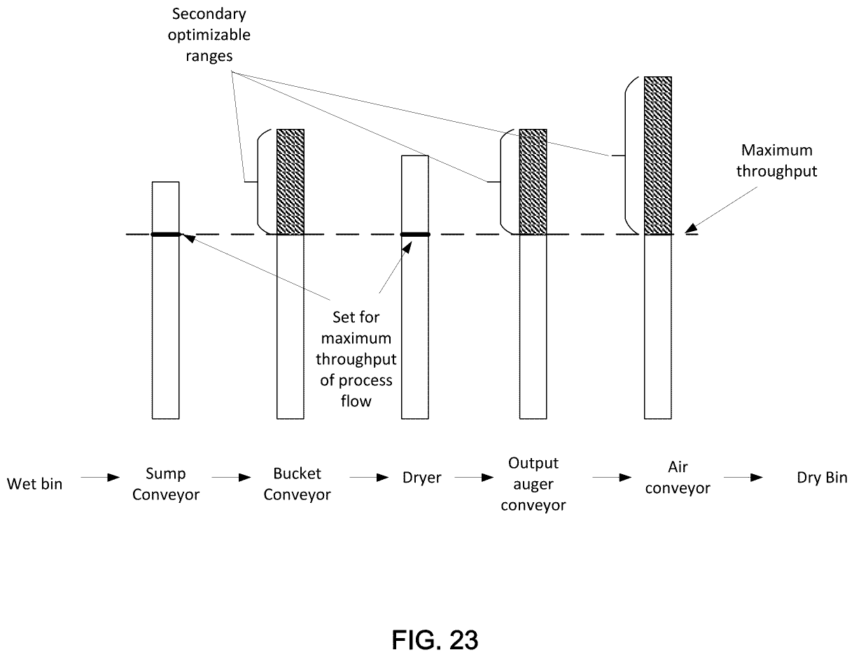

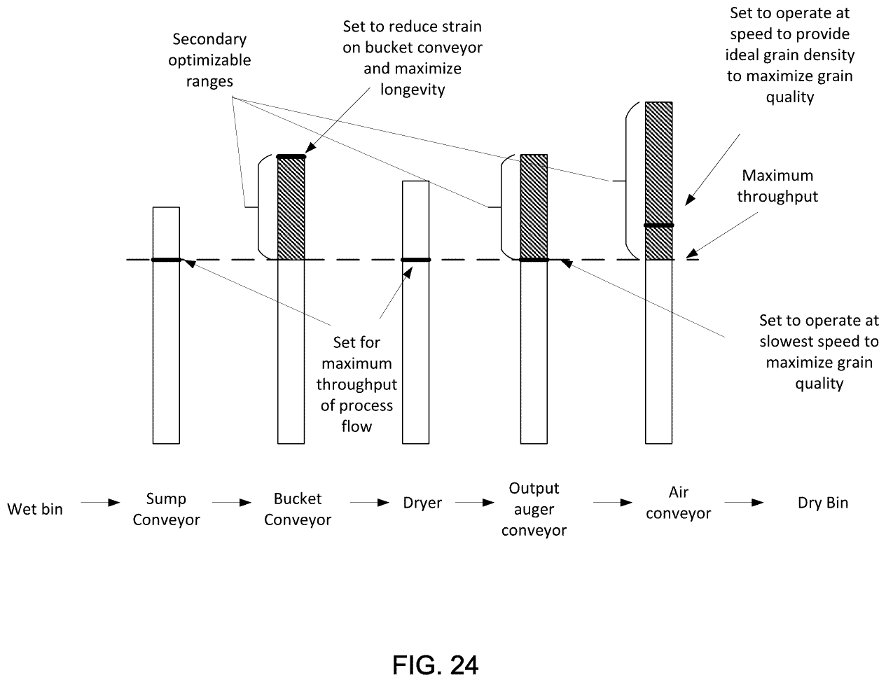

Continuing with the hypothetical example shown in FIGS. 18-20, FIGS. 23-24 show a graphical depiction of individual operating speed ranges for optimization of secondary performance parameters (e.g., of bucket conveyor, output auger conveyor, and air conveyor) after optimizing the flow for throughput as the primary performance parameter.

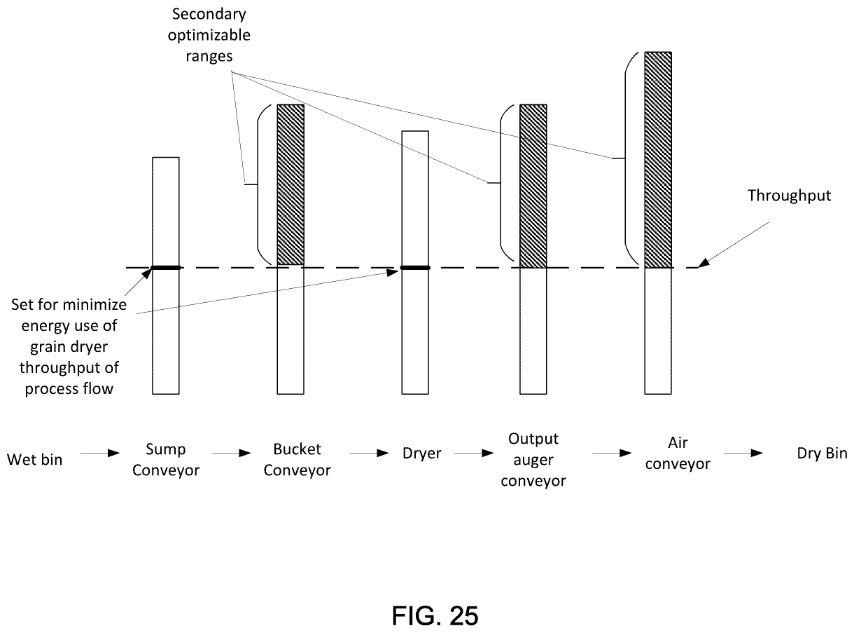

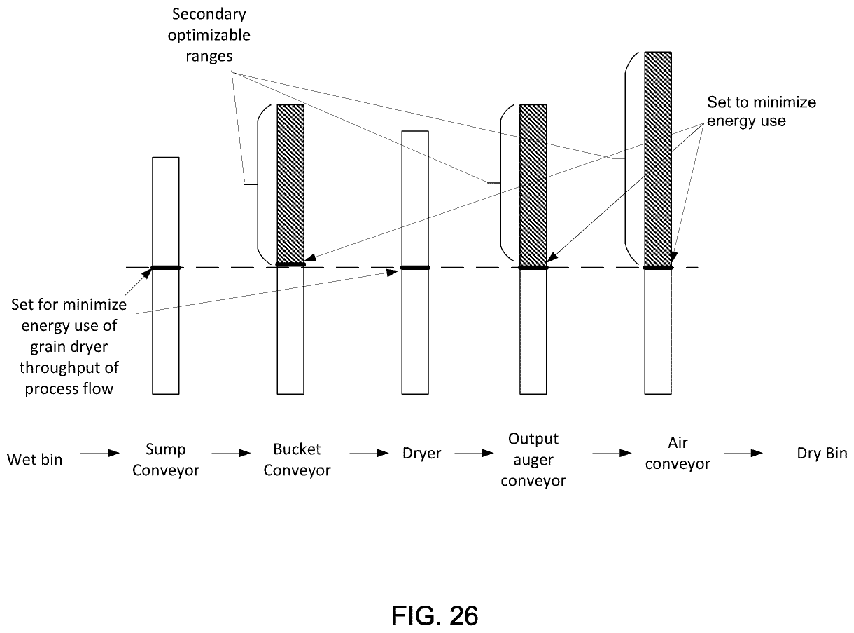

FIGS. 25-26 show a graphical depiction of another example optimization of the hypothetical example shown in FIGS. 18-20. In this example, FIG. 25 shows individual operating speed ranges for optimization of secondary performance parameters (e.g., of bucket conveyor, output auger conveyor, and air conveyor) after optimizing the flow for to minimize energy consumption by the grain dryer as the primary performance parameter. FIG. 26 shows operating speeds of bucket conveyor, output auger conveyor, and air conveyor further optimized to minimize energy used in bucket conveyor, output auger conveyor, and air conveyor.

However, the arrangements are not so limited. Rather, it is contemplated that in some various arrangements, adaptive control system 200 may be configured to optimize one or more control settings for any number of different primary performance parameters 210 and/or secondary performance parameters 216 which may include but are not limited to the example performance parameters discussed herein.

### Self-Optimization by Grain Handling Systems 12:

In one or arrangement, one or more grain handling systems 12 may be configured to perform self-optimization of one or more parameters in addition to or in lieu of optimization perform by adaptive control system 200. For example, in one or more arrangements, adaptive control system 200 may optimize and configure operation for a primary performance parameter (and possibly one or more secondary performance parameters. During operation, one or more grain handling systems 12 may further optimize their operation within ranges consistent with optimization directed by adaptive control system 200. In some various arrangements, grain handling systems 12 may be configured to self-optimize for various performance parameters including but not limited to, for example, energy use, lifespan/longevity, grain quality, and/or any other performance parameter. In one or more arrangements, self-optimization by grain handling systems 12 may be customizable (e.g., via a user interface of adaptive control system 200), for example to enable, disable, and/or configure optimization settings of self-optimization performed by grain handling systems 12.

### Customization of Constraints and Optimizations:

Optimizing control settings may involve balancing multiple interests that ultimately depends details of each particular operation on the priorities of the operator. In one or arrangements, adaptive control system 200 is configurable (e.g., by a user interface) for an operator to set constraints 214 and/or ranges of control setting 212 for grain handling systems 12, primary performance parameters 210, and/or secondary performance parameters 216 for various process flows and/or grain handling systems 12.

In some arrangements, adaptive control system 200 may be configurable (e.g., by a user interface) to specify constraints 214 and/or performance parameters 210/216 for optimization (e.g., primary or secondary) on a global level (e.g., for all process flows on a producer location), on a process flow level (e.g., for individual process flows, and/or on system level (e.g., for individual grain handling systems 12). For example, in some arrangements, constraints 214 may be set for individual grain handling systems 12 when the systems are installed.

For instance, similar to default control parameters (e.g., indicating actions for a system to take when affected by an error in a process flow) in one or more arrangements, operating constraints 214 may be specified when a grain handling system 12 and or intermediate control device 16 is installed. In one or more arrangements, adaptive control system 200 may be configured to automatically detect, determine, and/or retrieve control setting ranges and/or default operating constraints 214 for a particular grain handling system 12 when installed.

In some arrangements, adaptive control system 200 may provide a graphical user interface for a user to additionally or alternatively specify customized default operating constraints 214 and/or default optimization performance parameters 210/216 for grain handling systems 12.

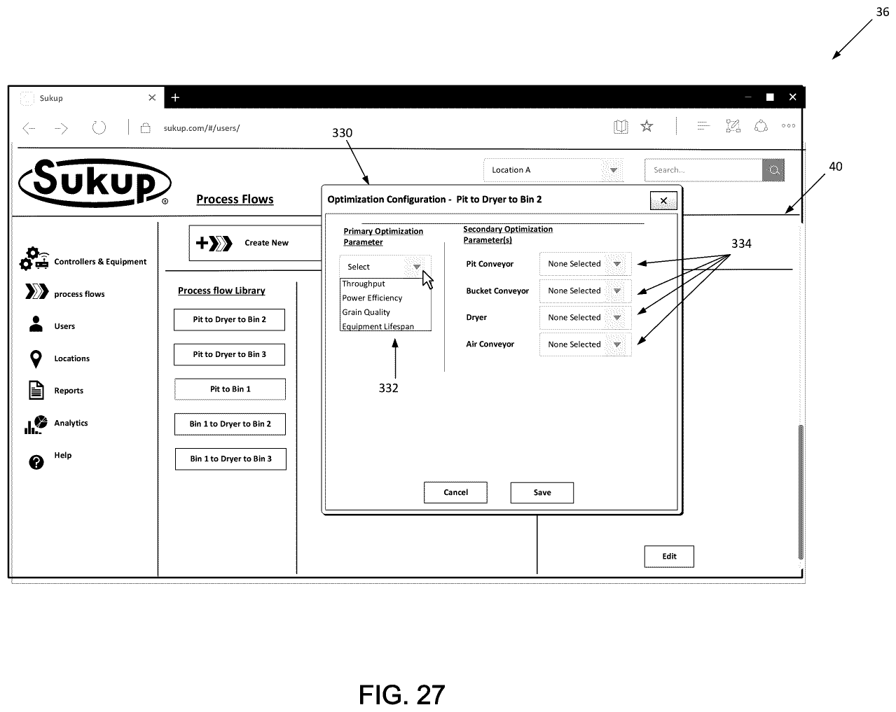

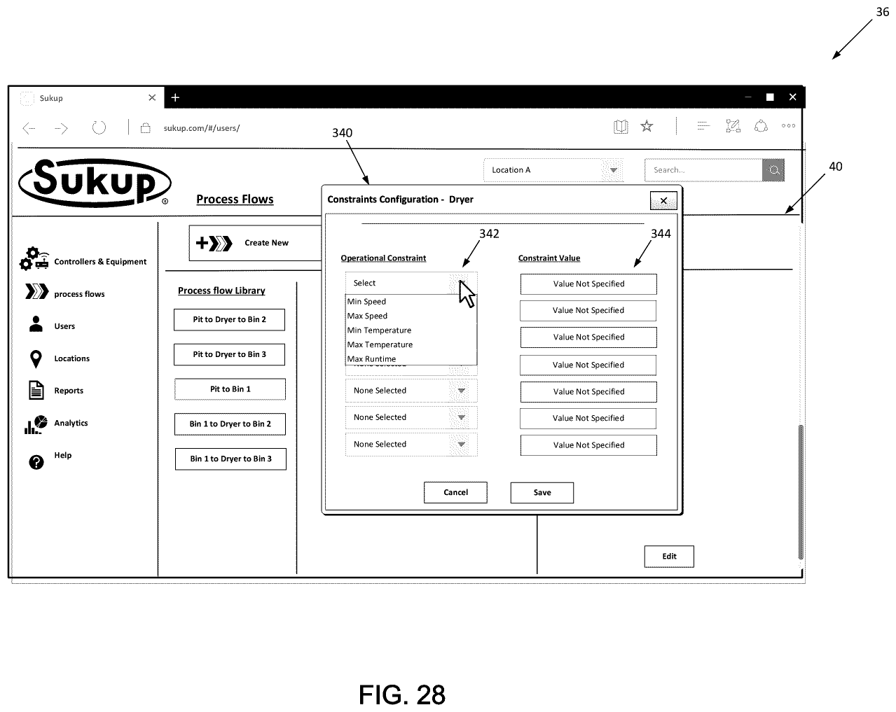

For example, FIGS. 27 and 28 show example pop up window interfaces for user configuration of default operating constraints 214 and/or default optimization performance parameters 210/216 that may be utilized by user interface 36 in one or more arrangements.

As shown in FIG. 27, the user interface 36 includes pop up window interface 330 includes a first selection interface 332 for users to select a primary performance parameter to use for optimization of a selected process flow. In this example, pop up window interface 330 includes a second selection interface 334 for users to select secondary performance parameter to use for optimization of individual grain handling systems 12 included in the process flow. Similarly, as shown in FIG. 28, the user interface 36 includes pop up window interface 340 includes a first selection interface 342 for users to select default operational constraints to be used when optimizing process flows including the selected grain handling system. In this example pop up window interface 340 also includes a second selection interface 344 for users to select values for the select operational constraints.

However, the arrangements are not so limited. Rather, it is contemplated that in some various arrangements, such constraints 214 may be specified for grain handling systems 12 at various times including but not limited to, for example, when installing or configuring the grain handling systems 12 or intermediate control devices 16, when creating or configuring process flows, or any other time a user may desire to adjust operating constraints 214. Similarly, in one or more arrangements, the graphical user interface of adaptive control system 200 may permit users to specify default secondary optimization to be performed for an individual grain handling system 12.

Similarly, in one or more arrangements, adaptive control system 200 may permit users to select primary and/or secondary performance parameters 210/216 at various times including but not limited to, for example, when configuring global settings, when creating or configuring process individual process flows, and/or when installing or configuring grain handling systems 12 or intermediate control devices 16 (as previously discussed), or any other time a user may desire to adjust performance parameters 210/216 for optimization.

In one or more arrangements, adaptive control system 200 may permit users to set how global-level, flow-level and system-level constraints/parameters should be prioritized when performing optimizations. For example, in some arrangements, adaptive control system 200 may be configured to perform optimization prioritizing the higher priority performance parameters/constraints first.

In one or more arrangements, constraints 214 are of the highest priority and are set as required conditions that must be satisfied. Such prioritization may be particularly useful to permit operators to consider and set constraints 214 once for an individual grain handling system 12, for example, and have such constraints 214 apply automatically in any process flow that may incorporate the grain handling system 12. Such prioritization may additionally or alternatively help to enforce operational limits for process flows that may be created in the future by persons that are less familiar with status and operation of some grain handling systems 12.

In one or more arrangements, in absence of contrary configuration by an operator, adaptive control system 200 is configured to adjust operation prioritizing constraints 214 first, primary performance parameters 210 second, and secondary performance parameters 218 third. However, the arrangements are not so limited. Rather, it is contemplated that in some various arrangements, adaptive control system 200 may be configured to utilize any number of priority levels and/or prioritize constraints/parameters in other orders.

In some arrangements, adaptive control system 200 may be configured to automatically detect conflicts between different constraints 214 and disable operation of a flow in response to detecting such conflict. In some arrangements, adaptive control system 200 may notify an operator of such conflict and permit the operator to adjust and/or override one or more of the hard constraints 214 until conflicts are resolved.

### Example Optimization Processes:

Some various different arrangements may optimize operation for selected performance parameters 210 (within compatible ranges of constraints 214) using various methods, processes, and/or techniques. For example, in some arrangements, operation of grain handling systems 12 for different control settings 212 may be predicted by adaptive control system 200 with a high degree of accuracy, thereby enabling adaptive control system 200 to determine appropriate control settings 212 to optimize operation computationally (e.g., via simulation of the process flow). As another example, in some arrangements, adaptive control system 200 may be configured to optimize operation by closely monitoring operation of grain handling systems 12 during operation and making dynamically incremental adjustments to improve operation for a selected performance parameter. As yet another example, in some arrangements, adaptive control system 200 may be configured to optimize operation by computationally determining control settings 212 for an estimated optimization, configuring grain handling systems 12 to operated according to the determined control settings 212, and then dynamically adjusting the control settings 212 during operation to refine optimization based on actual performance data.

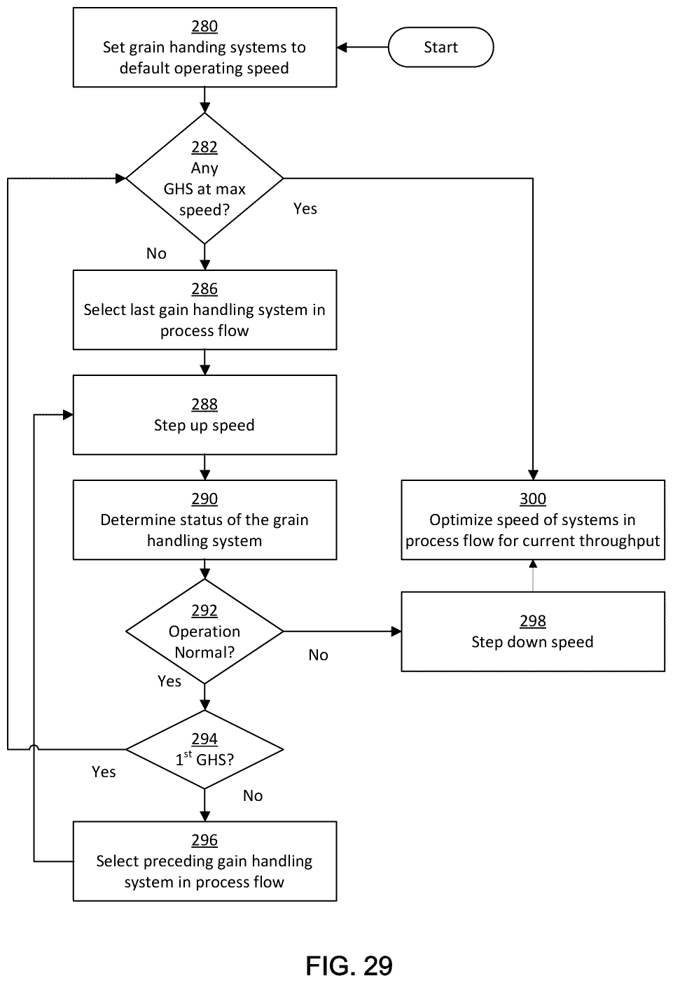

As an illustrative example, FIG. 29 shows an example process for optimization of operating speed of grain handling devices to maximize throughput, in accordance with one or more arrangements. In this example, the optimization is performed by incremental adjustment of grain handling systems 12 in real time during operation. More specifically, in this example, speeds are incrementally increased starting at the end of the process flow and moving toward the start of the process flow. This approach helps to prevents downstream grain handling systems 12 from becoming overloaded when throughput/speed of a grain handling system is increased.

In this example, the process starts at process block 280. At process block 280, adaptive control system 200 sets grain handling systems 12 to operate at default operating speeds. At decision block 282, adaptive control system 200 checks if any grain handling system 12 in the process flow is a maximum speed. In some various different arrangements, adaptive control system 200 may utilize various processes and/or means to determine if a grain handling system is a maximum speed including but not limited to, predefined power/speed settings and/or ranges, monitoring sensor/performance data and/or error/warning signals of grain handling systems 12, and/or any other method for determining when grain handling systems 12 are operating at maximum speed. If any grain handling system 12 in the process flow is operating at maximum speed, throughput of the process flow cannot be increased and may be considered to optimized for throughput. In such case, the optimization process proceeds to process block 300 where speed of grain handling systems 12 is optimized for the throughput (e.g., reduced to a minimum speed sufficient to provide the optimized throughput).

If no grain handling system 12 is operating at maximum speed, at decision block 282, a step-up speed in the process flow is initiated by proceeding to process block 286. At process block 286, the last grain handling system 12 in the process flow is selected. At process block 288, speed of the selected grain handling system 12 is increased. At process block 290, status of the grain handling system is determined (e.g., by retrieving sensor/status data from the grain handling system 12).

If operation is ever not normal for a selected grain handling at decision block 292, the process proceeds to process block 298, where speed is stepped back down (which should restore normal operation). At such point, the process flow may be considered to be operating at a maximum speed and the optimization process proceeds to process block 300, where speed of grain handling systems 12 is optimized for the throughput.

If operation of the grain handling system 12 is normal at decision block 292, and the selected grain handling system is not the first in the process flow at decision block 294, the process selects the next preceding grain handling system in the process flow, at process block 296, and loops back to process block 288. The process loops in this manner, either speed has been increased in all the grain handling systems 12 in the process flow (e.g., first grain handling system is selected at decision block 294) or a grain operating system begins to operate in error (i.e., at decision block 292).

When the first grain handling system 12 is selected with the process reaches decision block 294, speed has been successfully stepped up in each grain handling system in the process flow. At such point the process loops back to decision block 282. The process continues in this manner until a grain handling system 12 in the process flow is determined to be at maximum speed at decision block 282, as which point the process flow may be considered to be operating at a maximum speed and the optimization process proceeds to process block 300, where speed of grain handling systems 12 is optimized for the optimized throughput.

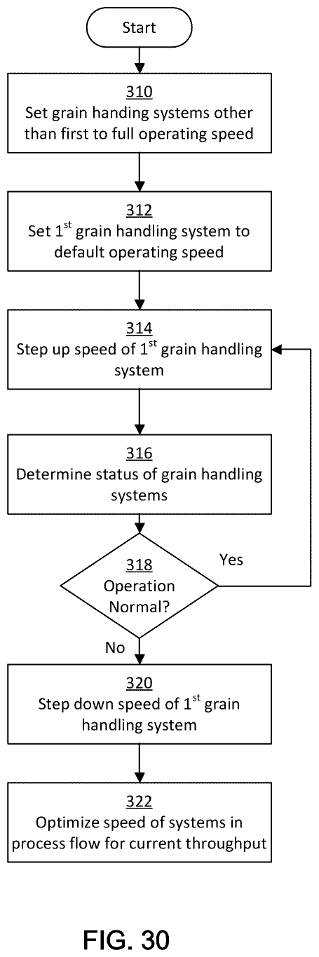

As another illustrative example, FIG. 30 shows another example process for optimization of operating speed of grain handling devices to maximize throughput, in accordance with one or more arrangements. In this example, the optimization is performed by generally ramping all grain handling systems 12 in the process flow, except the first grain handling system, up to their highest operating speed. Speed of the first grain handling system to inputs grain in the process flow is then slowly increased until status of another grain handling system indicates it is operating at maximum throughput. In some arrangements, maximum throughput may be detected, for example, by monitoring the flow of grain into and out of grain handling systems 12. When input flow of grain exceeds output flow of grain, the grain handling system is determined to be exceeding its maximum throughput.

In this example, the process starts at process block 310. At block 310, grain handling systems 12 in the process flow other than the first are set to operate at their highest speed. At process block 312, grain handling systems 12 is set to operate at its default operating speed. At process block 314, the speed of the first grain handling system is stepped up. At process block 316, the operating status of the grain handling systems 12 in the process flow is determined. If operation of grain handling systems 12 is normal at decision block 318, the process loops back to process block 314. The process loops in this manner until status indicates one of the grain handling systems is operating beyond its maximum throughput at decision block 318.

Once status indicates one of the grain handling systems is operating beyond its maximum throughput, the process proceeds from decision block 318 to process block 320. At process block 320, the speed of the first grain handling system is stepped down, which should restore the grain handling systems to normal status. At this point, the process flow may be considered to be running at maximum throughput. At process block 322, the optimization process optimizes speed of grain handling systems 12 for the optimized throughput (e.g., reduces speed to a minimum speed sufficient to provide the optimized throughput).

However, the arrangements are not limited to these example optimization processes. Rather, it is contemplated that in some various arrangements adaptive control system 200 may be configured to optimize operation using various additional or alternative methods, processes, and/or means.

Optimization with Artificial Intelligence:

In one or more arrangements, optimization processes of adaptive control system 200 and/or grain handling systems 12 may utilize various guided and/or unguided artificial intelligence, machine learning techniques and/or other analytics processes to evaluate available operating data (e.g., sensors data, operating settings, etc.) over time to, for example, identify optimal settings for grain handling systems for various scenarios and/or train artificial intelligence algorithms to determine optimal settings based on current sensor and/or other data. In various embodiments, such artificial intelligence and/or machine learning techniques may include but are not limited to, for example: neural networks, genetic algorithms, support vector machines, k-means, kernel regression, discriminant analysis and/or various combinations thereof. In different implementations, analysis may be performed locally, remotely, or a combination thereof. However, the arrangements are not so limited. Rather, it is contemplated that in some various arrangements, adaptive control system 200 and/or grain handling systems 12 may utilize various additional or alternative types of artificial intelligence/machine learning.

From the above discussion it will be appreciated that the system 10 presented herein improves upon the state of the art. More specifically, and without limitation, it will be appreciated that in one or more arrangements, an improved control system for grain handling systems is provided that improves upon the state of the art; that facilitates easy setup and configuration of grain handling systems; that facilitates setup and configuration of grain handling systems without manual programing; that automatically optimizes grain handling systems for one or more performance parameters; that dynamically optimizes grain handling systems during operation for one or more performance parameters; that is easy to use; that is scalable; that is adaptable; that is reliable; that can operate without an internet connection; that is easy to manufacture; that is durable; that has a robust design; that is relatively inexpensive; that is high quality; and/or that can be used with any grain handling system. These and other objects, features, or advantages of the disclosure will become apparent from the specification, figures, and claims. It will be appreciated by those skilled in the art that other various modifications could be made to the device without parting from the spirit and scope of this disclosure. All such modifications and changes fall within the scope of the claims and are intended to be covered thereby.

What is claimed:

1. A system for operating grain handling systems at a grain handling site, comprising:
an adaptive control system;
wherein the control system is configured to provide a user interface;
the adaptive control system communicatively connected to a one or more grain handling systems;
wherein the adaptive control system is configured to control operation of the grain handling systems to perform a sequential process flow;
wherein the adaptive control system is configured to dynamically adjust one or more control settings for the one or more grain handling systems during operation to optimize a performance parameter selected via the user interface.

2. The system of claim 1, wherein the optimization of the performance parameter selected via the user interface includes:
determining operating constraints specified for the one or more grain handling systems;
determining operational range of the one or more control settings for the one or more grain handling systems that comply with the determined operating constraints;
dynamically adjusting the one or more control settings for the one or more grain handling systems to optimize operation for the performance parameter.

3. The system of claim 1, wherein the adaptive control system is further configured to adjust the one or more control settings for the one or more grain handling systems to optimize operation of the one or more grain handling systems for a secondary performance parameter.

4. The system of claim 1, wherein the adaptive control system is further configured to dynamically adjust the one or more control settings for a subset of the one or more grain handling systems to optimize operation of the subset for a secondary performance parameter.

5. The system of claim 1, wherein the optimization of the performance parameter dynamically adjusts the one or more control settings to maximize throughput of the sequential process flow by:
determining a maximum throughput that can be provided by each of the one or more grain handling systems;
determining the grain handling system of the plurality having a lowest maximum throughput of the maximum throughputs; and
dynamically adjusting operating speed of other grain handling systems of the plurality based on the maximum throughput.

6. The system of claim 1, wherein the dynamically adjusting the one or more control settings for the one or more grain handling systems during operation to optimize the performance parameter includes repeatedly during operation:
measuring one or more operating conditions; and
adjusting the one or more control settings for the one or more grain handling systems based on the measured one or more operating conditions.

7. The system of claim 1, wherein the optimization of the performance parameter dynamically adjusts the one or more control settings to maximize throughput of the sequential process flow.

8. The system of claim 1, wherein the optimization of the performance parameter dynamically adjusts the one or more control settings to minimize energy consumption of the sequential process flow.

9. The system of claim 1, wherein the optimization of the performance parameter dynamically adjusts the one or more control settings to maximize lifespan of the one or more grain handling systems.

10. The system of claim 1, wherein the optimization of the performance parameter dynamically adjusts the one or more control settings to maximize grain quality.

11. The system of claim 1, wherein the adaptive control system is configured to determine which of the one or more grain handling systems has a lowest maximum throughput and dynamically optimize operating speed of other systems of the one or more grain handling systems based on the lowest maximum throughput.

12. The system of claim 1, wherein the adaptive control system is configured to dynamically adjust operating speed of the one or more grain handling systems during operation to maximize throughput in the sequential process flow by:
operating the one or more grain handling systems at respective initialization operating speeds; and
iteratively increasing operating speeds of the one or more grain handling systems until one of the one or more grain handling systems reaches its maximum operating speed.

13. A control system for a grain handling site, comprising:
a control system;
the control system configured to provide a first user interface;
wherein the first user interface is configured to facilitate the creation of a sequential process flow and selection of at a performance parameter;
wherein the creation of the process flow includes:
presenting a list of grain handling systems installed at the grain handling site; and
selecting one or more grain handling systems to be used in the sequential process flow from the list of grain handling systems;
wherein in response to a user executing the process flow, the control system is configured to prompt the selected one or more grain handling systems to operate to implement the sequential process flow;
wherein the control system is configured to dynamically adjust one or more control settings for the selected one or more grain handling systems during operation to optimize for the selected performance parameter.

14. The system of claim 13, wherein the optimization for the performance parameter includes:
determining operating constraints specified for the one or more grain handling systems;
determining operational range of the control settings for the one or more grain handling systems that comply with the determined operating constraints;
dynamically adjusting the one or more control settings for the one or more grain handling systems to optimize operation for the performance parameter.

15. The system of claim 13, further comprising dynamically adjusting the one or more control settings for the one or more grain handling systems to optimize operation of the one or more grain handling systems for a secondary performance parameter.

16. The system of claim 13, further comprising dynamically adjusting the one or more control settings for a subset of the one or more grain handling systems to optimize operation of the subset for a secondary performance parameter.

17. The system of claim 13, wherein the optimization of the performance parameter dynamically adjusts the one or more control settings to maximize throughput of the sequential process flow by:
determining a maximum throughput that can be provided by each of the one or more grain handling systems;
determining the grain handling system of the plurality having a lowest maximum throughput of the maximum throughputs; and
dynamically adjusting operating speed of other grain handling systems of the plurality based on the lowest maximum throughput.

18. The system of claim 13, wherein the dynamically adjusting the one or more control settings for the one or more grain handling systems during operation to optimize a performance parameter includes repeatedly during operation:
measuring one or more operating conditions; and
adjusting the one or more control settings for the one or more grain handling systems based on the measured one or more operating conditions.

19. The system of claim 13, wherein the optimization of the performance parameter dynamically adjusts the one or more control settings to maximize throughput of the sequential process flow.

20. The system of claim 13, wherein the optimization of the performance parameter dynamically adjusts the one or more control settings to minimize energy consumption of the sequential process flow.

21. The system of claim 13, wherein the optimization of the performance parameter dynamically adjusts the one or more control settings to maximize lifespan of the one or more grain handling systems.

22. The system of claim 13, wherein the optimization of the performance parameter dynamically adjusts the one or more control settings to maximize grain quality.

23. The system of claim 13, wherein the adaptive control system is configured to determine which of the one or more grain handling systems has a lowest maximum throughput and dynamically optimize operating speed of other systems of the one or more grain handling systems based on the lowest maximum throughput.

24. The system of claim 13, wherein the adaptive control system is configured to dynamically adjust operating speed of the one or more grain handling systems during operation to maximize throughput in the sequential process flow by:
operating the one or more grain handling systems at respective initialization speeds; and
iteratively increasing operating speeds of the one or more grain handling systems until one of the one or more grain handling systems reaches its maximum operating speed.

25. A method for controlling grain handling systems for a grain handling site, comprising:
providing a user interface configured to facilitate the creation of a process flow;
using the user interface, creating the process flow by:
presenting a list of grain handling systems installed at the grain handling site;
selecting one or more grain handling systems to be used in the process flow from the list of grain handling systems; and
using the user interface, selecting a performance parameter;
prompting the selected one or more grain handling systems to implement the process flow; and
adjusting operation of the one or more grain handling systems to optimize the process flow for the performance parameter.

26. The method of claim 25, wherein the optimization of the process flow for the performance parameter includes:
determining operating constraints specified for the one or more grain handling systems;
determining operational range of the control settings for the one or more grain handling systems that comply with the determined operating constraints;
dynamically adjusting control settings for the one or more grain handling systems to optimize operation for the performance parameter.

27. The method of claim 25, further comprising dynamically adjusting the control settings for the one or more grain handling systems to optimize operation of the one or more grain handling systems for a secondary performance parameter.

28. The method of claim 25, further comprising dynamically adjusting the control settings for a subset of the one or more grain handling systems to optimize operation of the subset for a secondary performance parameter.

29. The method of claim 25, wherein the optimization of the process flow for performance parameter dynamically adjusts one or more control settings of the one or more grain handling systems to maximize throughput of the sequential process flow by:
determining a maximum throughput that can be provided by each of the one or more grain handling systems;
determining the grain handling system of the plurality having a lowest throughput of the maximum throughput; and
dynamically adjusting operating speed of other grain handling systems of the plurality based on the lowest throughput.

30. The method of claim 25, wherein the optimization of the process flow for the performance parameter includes:
measuring one or more operating conditions; and
adjusting the one or more control settings for the one or more grain handling systems based on the measured one or more operating conditions.

31. The method of claim 25, wherein the optimization of the process flow for the performance parameter dynamically adjusts the one or more control settings of the one or more grain handling systems to maximize a throughput of the sequential process flow.

32. The method of claim 25, wherein the optimization of the process flow for the performance parameter dynamically adjusts one or more control settings of the one or more grain handling systems to minimize energy consumption of the sequential process flow.

33. The method of claim 25, wherein the optimization of the performance parameter dynamically adjusts one or more control settings to maximize lifespan of the one or more grain handling systems.

34. The method of claim 25, wherein the optimization of the performance parameter dynamically adjusts the one or more control settings of the one or more grain handling systems to maximize grain quality.

35. A system for operating grain handling systems at a grain handling site, comprising:
an adaptive control system;
wherein the control system is configured to provide a user interface;
the adaptive control system communicatively connected to a one or more grain handling systems;
wherein the adaptive control system is configured to control operation of the grain handling systems to perform a sequential process flow specified by a user via the user interface;
wherein the adaptive control system is configured to dynamically adjust operating speed of the one or more grain handling systems during operation to maximize throughput in the sequential process flow by:
operating the one or more grain handling systems at respective initialization operating speeds; and
iteratively increasing operating speeds of the one or more grain handling systems until one of the one or more grain handling systems reaches its maximum operating speed.
